(19) United States
(12) Patent Application Publication
(10) Pub. No.: US 2006/0080116 A1
(43) Pub. Date: Apr. 13, 2006

(54) Web-based employee onboarding management and tracking software

(75) Inventors: Jeffrey Maguire, Shaker Heights, OH (US); Robert Baskette, Aurora, OH (US)

Correspondence Address: Law Offices of John D. Gugliotta, PE, Esq., 202 Delaware Building, 137 South Main Street, Akron, OH, 44308, US

(73) Assignees: Newhouse Communications, Inc.; d.b.a. Knowbase Networks

(21) Appl. No.: 10/962,237

(22) Filed: Oct. 12, 2004

(51) Int. Cl. G06Q 99/00

(52) U.S. Cl. 705/1

(57) ABSTRACT

The current system design is an network connected client (including but not limited to any Internet browser, Intranet client, PDA device, etc.)-based employee onboarding and tracking software. The present invention utilizes a very detailed and comprehensive system of checklists. These checklists create structure, accountability, accuracy, and completeness with built in safeguards from initial job offer through employee training and the first day of the job. The unique characteristics of the present invention can effortlessly help recruiters, managers, human resource specialists, training coordinators, supervisors process and hire more employees with increased productivity. It is envisioned as a web-based application that can be replicated for multiple client usage with independent databases.

### RELATED APPLICATIONS

There are no previously filed, nor currently any co-pending applications, anywhere in the world.

### BACKGROUND OF THE INVENTION

1. Field of the Invention

The present invention relates generally to employee hiring management systems, and, more particularly, to any network-connected client (such as an Internet™ browser) based employee hiring management and tracking software

2. Description of the Related Art

As is generally known to any individual or corporation who employ workers, the hiring process is vitally important, yet lack any rigorous or methodical system or device to insure successful completion of the proper forms, background investigations, drug screening and the like.

The final processes of the hiring process are generally referred to as the onboarding process. Onboarding is the process of acquiring all required and optional, properly filled out, legally signed and legally binding forms and paperwork needed to convert a job candidate into an employee. The usual onboarding process is comprised of the candidate manually filling out and signing a set of between 3 to 20 paper forms. These forms are then carried, faxed or mailed to one or multiple processing sites where some amount of the information is converted to electronic form and entered into various manual and computerized management systems. The paper forms are then filed and stored as legal proof of signature.

Further, it is common for companies that have multiple people to be involved in all of the varying facets of employee hiring from the direct supervisor, manager, human resource department, presidents, vice-presidents and the like, and to allow these people to work from home, field sites or remote offices. Such remoteness causes multiple paper and electronic databases to be set up. These databases are set up from manually completed paper forms, facsimiles, emails and the like, and are highly prone to errors. Even if employee hiring software is installed on each machine, it is difficult to keep these mixed medium databases synchronized. This database synchronization becomes very burdensome over time to identify and correct problems related to specific office locations, filing locations, networks, and the like.

A search of the available employee hiring software packages found that none of them performed the onboarding process with regards to the completeion of all of the forms, W-2, I-9, pay roll deposits, and the like, with digital signatures to legally bind and manage said documents.

Consequently, a need has been felt for providing an apparatus and method for providing a network-connected client (such as an Internet™ browser)-based employee hiring and tracking software that uses a readily available network-connected client (such as an Internet browser) and can be accessed via almost any computer and any computer network, regardless of platform type or location.

### SUMMARY OF THE INVENTION

It is therefore an object of the present invention to provide an improved network connected client-based onboarding and tracking software system.

It is a feature of the present invention to provide and create a centralized database available to all qualified personnel who handle employee hirings.

Another feature of the present invention is that it uses any network connected client including the Internet™ to link all authorized users involved in the hiring process together; thereby creating a central database.

Yet another feature of the present invention is that it enables the electronic completion, field validation, digital signature, and proper storage and tracking and administration of the documents associated with the hiring process.

Still another feature of the present invention is that it allows access to the system via any network connected client (including but not limited to any internet browser, Intranet client, PDA device, etc.) from any computer or device connected to the Internet (or other applicable network without regards to computer platform, operating systems, hardware, access means or the like.

It is a still further feature and advantage of the present invention to provide such a method and system which supports unlimited geographical service centers with highly scaleable features to accommodate future growth.

It is another feature and advantage of the present invention to provide such a method and system which replaces manual procedures with automated management tools to maximize the central management control and to minimize the cost of operation.

It is also a feature and advantage of the present invention to provide such a method and system with 24 hours a day and 7 days a week operation.

An advantage of the present invention is that it allows employee hiring to be processed in a timely fashion with a minimum number of paper-based transactions.

Briefly described according to the preferred embodiment of the present invention, a system is provided that accomplishes the following:
Ensures that all proper governmental-required, employer-required and optional paperwork and screening are completed and digitally signed, on-line, before the new employee begins work;
Builds a current, centralized database of all pertinent information relating the hiring of a new employee including forms, screening, background checks, training and the like;
Allows authorized hiring personnel and managers to access database information through an Internet™ connection and a common web-browser (or any other network and other connected client software and any other conned interface device);
Builds a database of all potential new hires and new employees in real time.
   Additionally, the present invention:
Keeps track of present status of all new hires;
Insures timely transaction of new employee ensuring quick productivity for the hiring firm;
Allows hiring personnel to access and control the contents of the database from almost any location in the world, thus improving productivity and continuation of business, regardless of a lost business site;

The current system design is a network connected client (including but not limited to any Internet browser, Intranet client, PDA device, etc.)-employee hiring database that tracks and monitors the onboarding phase of the employee hiring process. The present invention utilizes a very detailed and comprehensive system of checklists. These checklists create structure, accountability, accuracy, and completeness with built in safeguards from initial job offer through employee training and the first day of the job. The unique characteristics of the present invention can effortlessly help recruiters, managers, human resource specialists, training coordinators, supervisors process and hire more employees with increased productivity. It is a network connected client (including but not limited to any Internet browser, Intranet client, PDA device, etc.)-based application that can be replicated for multiple client usage with independent databases.

DESCRIPTIVE KEY

| | |
|---|---|
| 10 | network connected client |
| | (including but not limited to |
| | any Internet browser, Intranet |
| | client, PDA device, etc.) - |
| | based employee onboarding |
| | management and tracking |
| | software |
| 15 | screen shot of a main login |
| | screen |
| 20 | first user name field |
| 25 | first password field |
| 30 | login button |
| 35 | instruction screen for hiring |
| | manager |
| 40 | first instructions |
| 45 | first continue button |
| 50 | first print button |
| 55 | main menu selection screen |
| | for hiring manager |
| 60 | second instructions |
| 65 | first selected form link |
| 70 | second selected form link |
| 75 | screen shot of a first selected |
| | form instruction screen |
| 80 | third instructions |
| 85 | screen shot of a typical input |
| | screen for first selected input |
| | form |
| 90 | first input fields |
| 95 | second continue button |
| 100 | second print button |
| 105 | first back button |
| 110 | screen shot of a second |
| | selected form instruction |
| | screen |
| 115 | fourth instructions |
| 120 | screen shot of a typical input |
| | screen for second selected |
| | input form |
| 126 | second input fields |
| 130 | third continue button |
| 135 | third print button |
| 140 | second back button |
| 145 | screen shot of a hiring |
| | manager manage employees |
| | screen |
| 150 | list of potential employees |
| | undergoing hiring process |
| 155 | first status columns |
| 160 | screen shot of a report test |
| | screen |
| 165 | first pull-down start date filter |
| 170 | first pull-down stop date filter |
| 175 | first reporting period |
| 180 | first reporting data fields |
| 185 | first help button |
| 190 | first logout button |
| 195 | first main menu button |
| 200 | screen shot of a hiring |
| | manager help screen |
| 205 | first help topics |
| 210 | first close button |
| 215 | screen shot of a hiring |
| | manager logout screen |
| 220 | first re-login button |
| 225 | screen shot of a main menu |
| | selection screen for |
| | background screening |
| | administrator |
| 230 | first change my password |
| | button |
| 235 | manage employees button |
| 240 | first reporting button |
| 245 | screen shot of a background |
| | screening administrator |
| | password change screen |
| 250 | first current password field |
| 255 | first new password field |
| 260 | first confirm password field |
| 265 | screen shot of background |
| | screening administrators |
| | manage employees screen |
| 270 | list of potential employees |
| | undergoing background |
| | screening process |
| 275 | second status columns |
| 280 | screen shot of a users with |
| | pending background check |
| | results screen |
| 285 | screen shot of a background |
| | screening administrators |
| | reporting screen |
| 290 | second pull-down start date |
| | filter |
| 295 | second pull-down stop date |
| | filter |
| 300 | second reporting period |
| 305 | second reporting data fields |
| 310 | second help button |
| 315 | second logout button |
| 320 | second main menu button |
| 325 | screen shot of a background |
| | screening administrator help |
| | screen |
| 330 | second help topics |
| 335 | second close button |
| 340 | screen shot of a background |
| | screening administrator logout |
| | screen |
| 345 | second re-login button |
| 350 | screen shot of a main menu |
| | screen for the employee |
| 355 | access point for first selected |
| | form link |
| 360 | access point for second |
| | selected form link |
| 365 | screen shot of first page of |
| | first selected form |
| 370 | screen shot of second page of |
| | first selected form |
| 375 | screen shot of third page of |
| | first selected form |
| 380 | screen shot of first page of |
| | second selected form |
| 385 | screen shot of second page of |
| | second selected form |
| 390 | screen shot of a employee |
| | password change screen |
| 395 | second current password field |
| 400 | second new password field |
| 405 | second confirm password |
| | field |
| 410 | screen shot of an employee |
| | help screen |
| 415 | third topics |
| 420 | third close button |
| 425 | screen shot of an employee |
| | logout screen |
| 430 | third re-login button |
| 435 | screen shot of a main menu |
| | selection screen for the |
| | human resource administrator |
| 440 | second change my password |
| | button |
| 445 | administrative control button |
| 450 | second reporting button |
| 455 | third help button |
| 460 | third logout button |
| 465 | third main menu button |
| 470 | view template button |
| 475 | screen shot of a human |
| | resource administrator |
| | password change screen |
| 480 | third current password field |
| 485 | third new password field |
| 490 | third confirm password field |
| 495 | screen shot of a |
| | administration menu screen |
| | for the human resource |
| | administrator |
| 500 | manage work locations button |
| 505 | manage base wage/salary |
| | types button |
| 510 | manage commission types |
| | button |
| 515 | manage bonus types button |
| 520 | manage job position button |
| 525 | manage administrators button |
| 530 | manage drug screen |
| | administrators button |
| 535 | manage regional managers |
| | button |
| 540 | manage employees button |
| 545 | screen shot of a work location |
| | screen for the human |
| | resource administrator |
| 550 | screen shot of a manage |
| | Base Wage/Salary Types for |
| | the human resource |
| | administrator |
| 555 | screen shot of a manage |
| | Commission Types screen for |
| | the human resource |
| | administrator |
| 560 | screen shot of a manage |
| | bonus types screen for the |
| | human resource administrator |
| 565 | screen shot of a manage job |
| | position screen for the human |
| | resource administrator |
| 570 | screen shot of a manage |
| | administrators screen for the |
| | human resource administrator |
| 575 | screen shot of a manage drug |
| | screen administrators screen |
| | for the human resource |
| | administrator |
| 580 | screen shot of a manage |
| | regional managers screen for |
| | the human resource |
| | administrator |
| 585 | screen shot of a manage |
| | employees screen for the |
| | human resource administrator |
| 590 | screen shot of a reporting |
| | screen for the human |
| | resource administrator |
| 595 | third pull-down start date filter |
| 600 | third pull-down stop date filter |
| 605 | third reporting period |
| 610 | third reporting data fields |
| 615 | third help button |
| 620 | third logout button |
| 625 | third main menu button |
| 630 | screen shot of a help screen |
| | for the human resource |
| | administrator |
| 635 | fourth topics |
| 640 | fourth close button |
| 645 | screen shot of a logout screen |
| | for the human resource |
| | administrator |
| 650 | fourth re-login button |
| 655 | screen shot of a login screen |
| | for the training manager |
| 660 | second user name field |
| 665 | second password field |
| 670 | screen shot of a main menu |
| | screen for the training |
| | manager |
| 675 | screen shot of a my courses |
| | main menu screen for a |
| | training manager |
| 680 | list of training courses |
| 685 | screen shot of a detailed |
| | course menu screen for the |
| | training manager |
| 690 | specific lesson of a training |
| | course |

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a screen shot of a main login screen for the web-based employee hiring management and tracking software, according to the preferred embodiment of the present invention;

FIG. 2 is a screen shot of instruction screen for how hiring manager should use the web site;

FIG. 3 is a screen shot of a main menu selection screen for hiring manager;

FIG. 4 is a screen shot of a IRS form I-9 Instruction screen;

FIG. 5 is a screen shot of a typical input screen for form I-9 fields;

FIG. 6 is a screen shot of a IRS form W4 instruction screen;

FIG. 7 is a screen shot of a typical input screen for form W4 fields;

FIG. 8 is a screen shot of a hiring manager manage employees screen;

FIG. 9 is a screen shot of a report test screen;

FIG. 10 is a screen shot of a hiring manager help screen;

FIG. 11 is a screen shot of a hiring manager logout screen;

FIG. 12 is a screen shot of a main menu selection screen for background screening administrator;

FIG. 13 is a screen shot of a background screening administrator password change screen;

FIG. 14 is a screen shot of background screening administrators manage employees screen;

FIG. 15 is a screen shot of a users with pending background check results screen;

FIG. 16 is a screen shot of a background screening administrators reporting screen;

FIG. 17 is a screen shot of a background administrators help screen;

FIG. 18 is a screen shot of a background administrators logout screen;

FIG. 19 is a screen shot of a main menu screen for the employee;

FIG. 20 is a screen shot of a first IRS Form I-9 screen to print;

FIG. 21 is a screen shot of a second IRS Form I-9 screen to print;

FIG. 22 is a screen shot of a third IRS Form I-9 screen to print;

FIG. 23 is a screen shot of a first IRS Form W-4 screen to print;

FIG. 24 is a screen shot of a second IRS Form W-4 screen to print;

FIG. 25 is a screen shot of an employee password change screen;

FIG. 26 is a screen shot of an employee help screen;

FIG. 27 is a screen shot of an employee logout screen;

FIG. 28 is a screen shot of a main menu selection screen for the HR administrator;

FIG. 29 is a screen shot of a change my password screen for the HR administrator;

FIG. 30 is a screen shot of a administration menu screen for the HR administrator;

FIG. 31 is a screen shot of a work location screen for the HR administrator FIG. 32 is a screen shot of a manage Base Wage/Salary Types for the HR administrator;

FIG. 33 is a screen shot of a manage Commission Types screen for the HR administrator;

FIG. 34 is a screen shot of a manage Bonus Types screen for the HR administrator;

FIG. 35 is a screen shot of a manage Job Position screen for the HR administrator;

FIG. 36 is a screen shot of a manage Administrators screen for the HR administrator;

FIG. 37 is a screen shot of a manage Drug Screen Administrators screen for the HR administrator;

FIG. 38 is a screen shot of a manage Regional Managers screen for the HR administrator;

FIG. 39 is a screen shot of a manage Employees screen for the HR administrator;

FIG. 40 is a screen shot of a reporting screen for the HR administrator;

FIG. 41 is a screen shot of a help screen for the HR administrator;

FIG. 42 is a screen shot of a logout screen for the HR administrator;

FIG. 43 is a screen shot of a login screen for the training manager;

FIG. 44 is a screen shot of a main menu screen for the training manager;

FIG. 45 is a screen shot of a my courses main menu screen for the training manager; and

FIG. 46 is a screen shot of a detailed course menu screen for the training manager.

### DESCRIPTION OF THE PREFERRED EMBODIMENTS

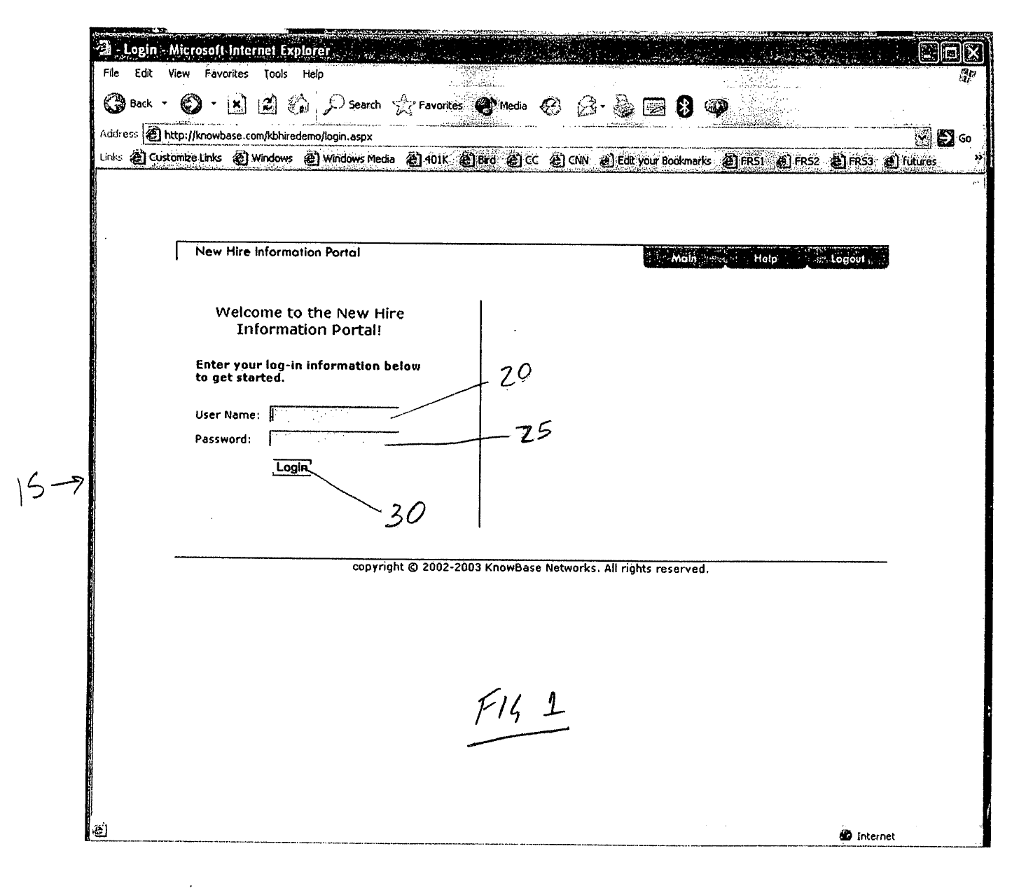

The best mode for carrying out the invention is presented in terms of its preferred embodiment, herein depicted within the FIGS. 1 through 46.

1. Detailed Description of the Figures

Referring to FIG. 1, network connected client (including but not limited to any Internet browser, Intranet client, PDA device, etc.)-based employee onboarding management and tracking software 10 discloses a screen shot of a main login screen 15, according to the preferred embodiment of the present invention. The screen shot of a main login screen 15 presents a first user name field 20 and a first password field 25 in the customary manner along with a login button 30. network connected client (including but not limited to any Internet browser, Intranet client, PDA device, etc.)-based employee onboarding management and tracking software 10 uses the supplied information which correlates to a database to determine what type of user is accessing the web based employee hiring management and tracking software 10 and to determine which subsequent screen should be presented to the user. The choices for following screens are envisioned to be hiring manager, background screening administrator, employee, Human Resource (HR) administrator, and training manager.

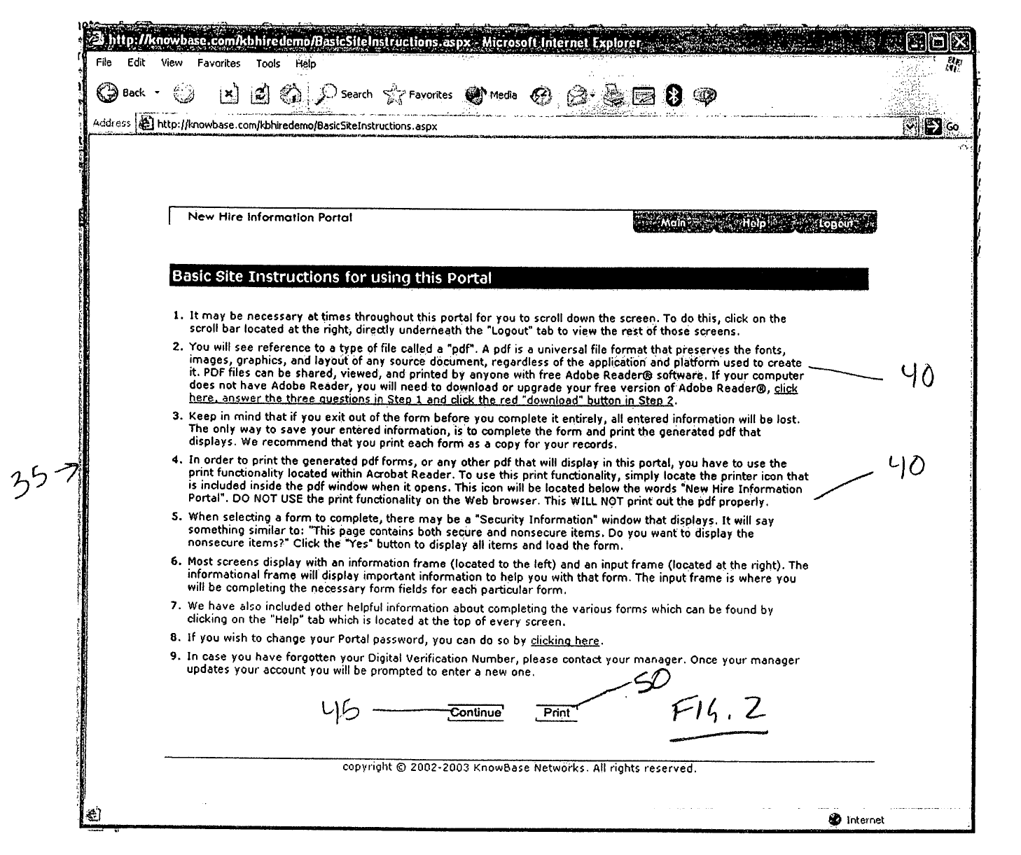

Referring next to FIG. 2 is a instruction screen for hiring manager 35 is disclosed, which provides detailed instructions on how the hiring manager should use the web based employee hiring management and tracking software 10. A series of first instructions 40 are provided on the screen of which, once read, allows the user to continue on with the use of a first continue button 45. Should the user wish to print out the first instructions 40 for later reference and continuous availability, a first print button 50 is provided as well.

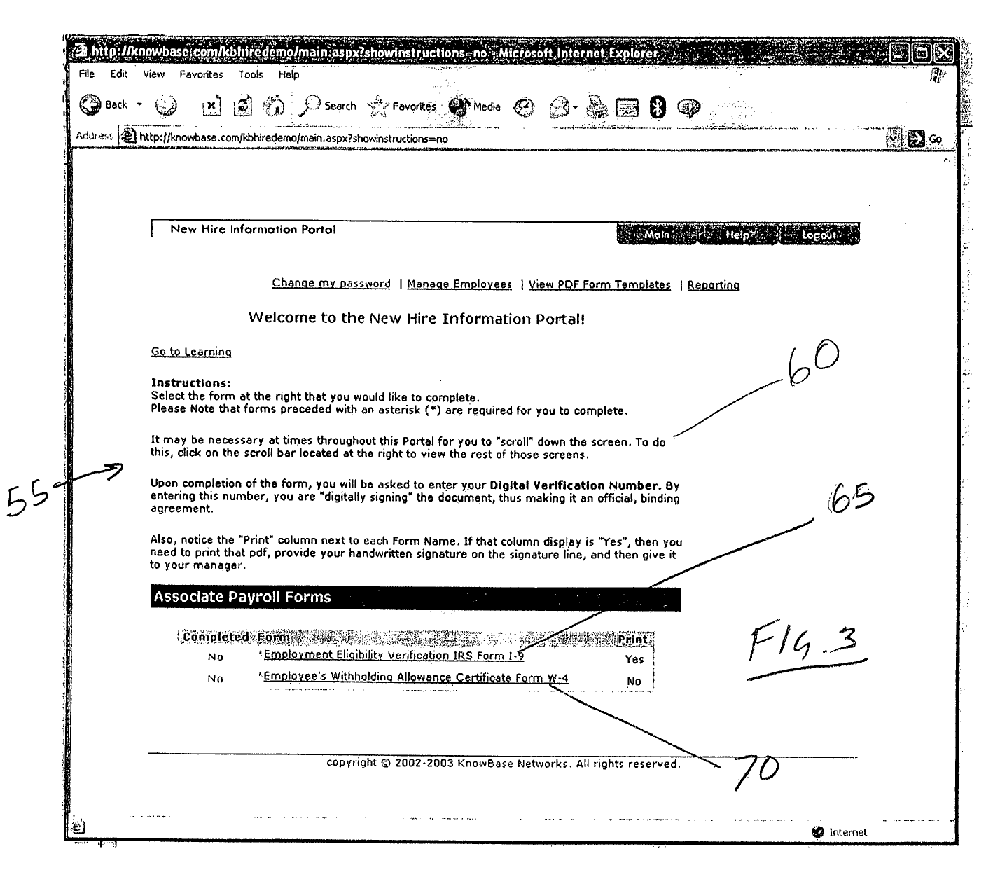

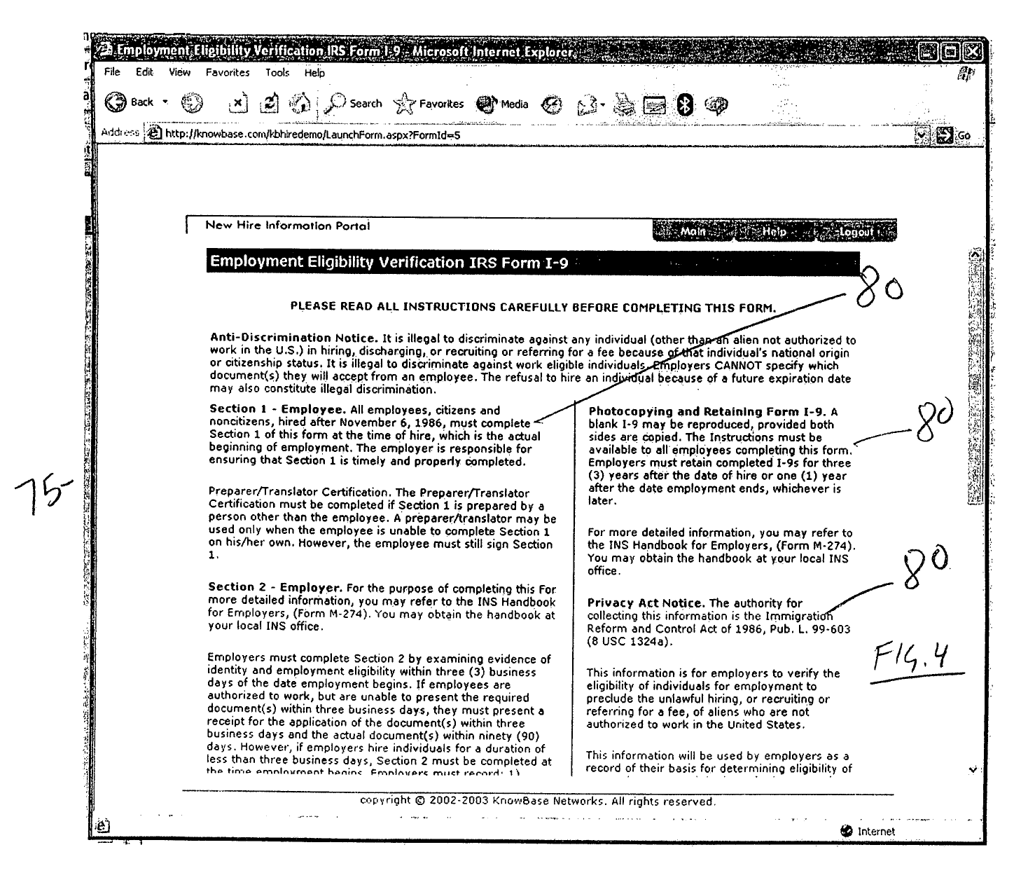

Referring now to FIG. 3, a screen shot of a main menu selection screen for hiring manager 55 is depicted. This screen provides second instructions 60 for additional clarification. A first selected form link 65 and a second selected form link 70 provide access to multiple governmental forms which must be completed prior to employment. It is envisioned that first selected form link 65 and the second selected form link 70 would be the form I-9 and W4 respectively, however the web based employee hiring management and tracking software 10 can handle any type and any amount of required forms, and as such should not be interpreted as a limiting factor of the present invention.

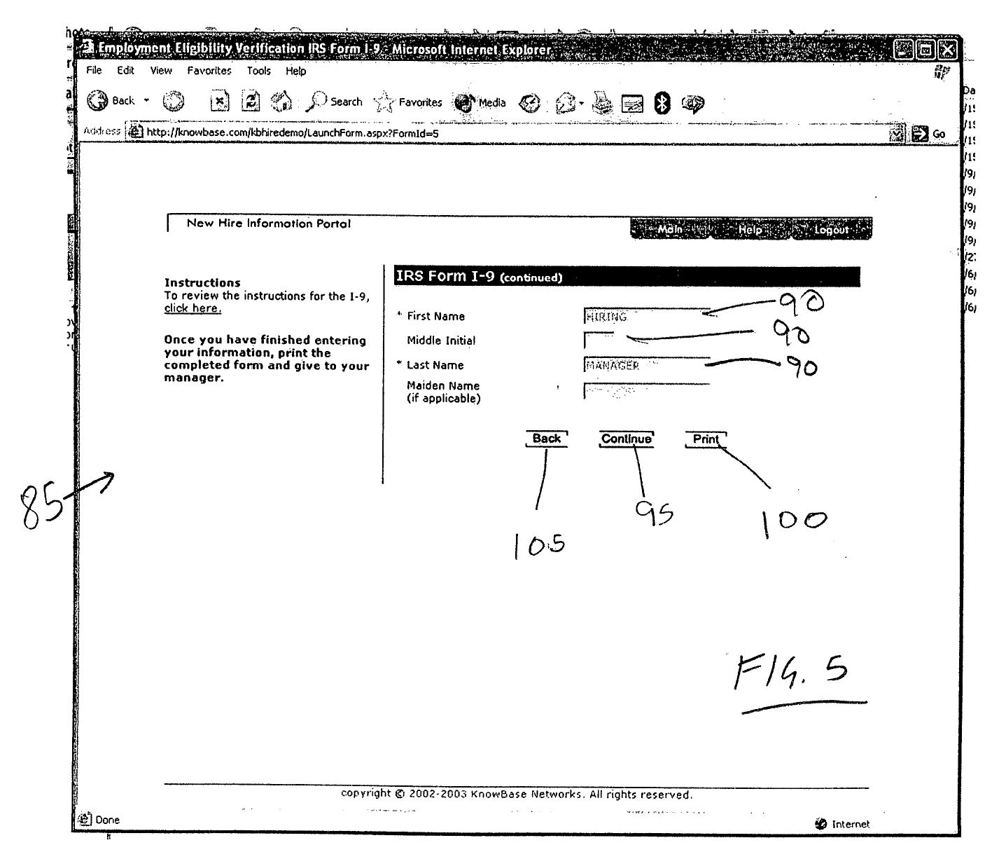

Referring now to FIG. 4, a screen shot of a first selected form instruction screen 75 is depicted. The screen shot of a first selected form instruction screen 75 provides a series of third instructions 80 to aid the hiring manager in verification of completeness of the first selected form link 65 as shown in FIG. 3. The third instructions 80 provided here are for the I-9 form for illustrative purposes. Once viewed and acknowledged, the user is provided with the actual form on-line for completion as will be described herein below.

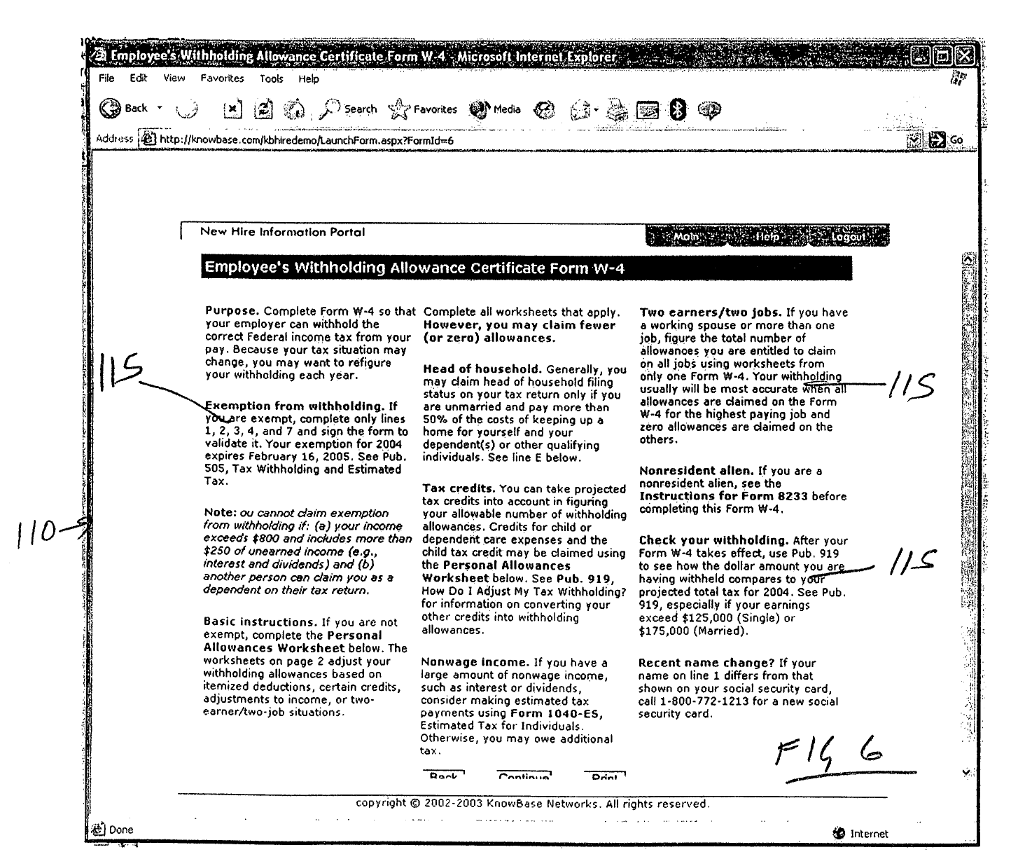

Referring next to FIG. 5, a screen shot of a typical input screen for first selected input form 85 is presented. The screen shot of a typical input screen for first selected input form 85 represents a series of first input fields 90 which must be completed. A second continue button 95 allows the user to continue on to all necessary screens which will populate all data fields in said form. Once completed, a second print button 100 allows the user to print out said form. Should the user wish to review prior inputted data, a first back button 105 is provided to allow prior screens to be presented.

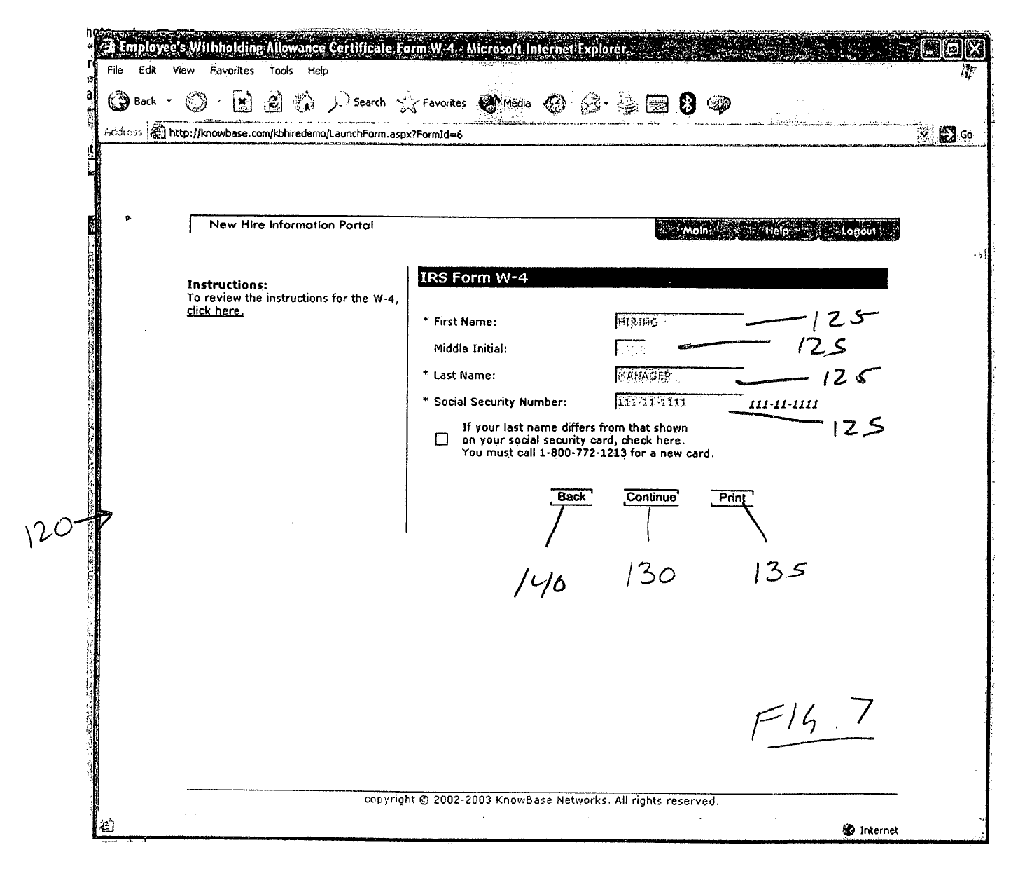

Referring next to FIG. 6, a screen shot of a second selected form instruction screen 110 depicted. The screen shot of a second selected form instruction screen 110 provides a series of fourth instructions 115 to aid the hiring manager in verification of completeness of the second selected form link 70 as shown in FIG. 3. The fourth instructions 115 provided here are for the W4 form for illustrative purposes. Once viewed and acknowledged, the user is provided with the actual form on-line for completion as will be described herein below.

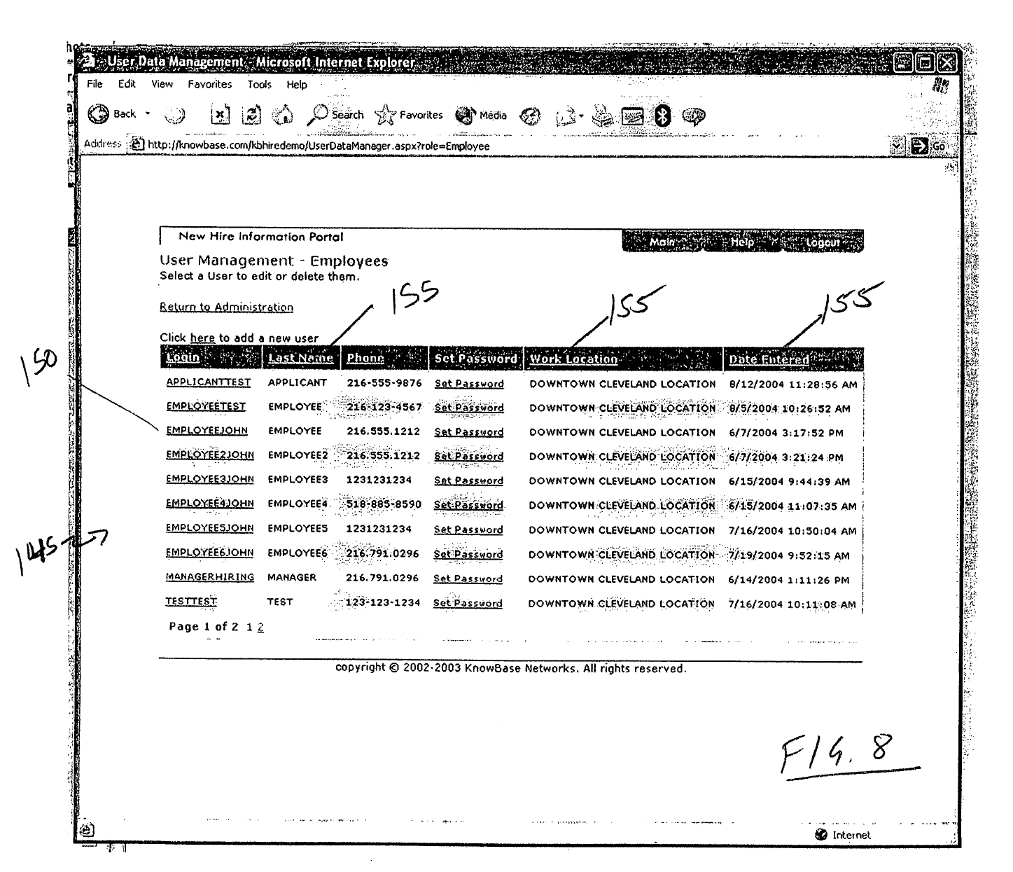

Referring next to FIG. 7, a screen shot of a typical input screen for second selected input form 120 is presented. The screen shot of a typical input screen for second selected input form 120 represents a series of second input fields 125 which must be completed. A third continue button 130 allows the user to continue on to all necessary screens which will populate all data fields in said form. Once completed, a third print button 135 allows the user to print out said form. Should the user wish to review prior inputted data, a second back button 140 is provided to allow prior screens to be presented.

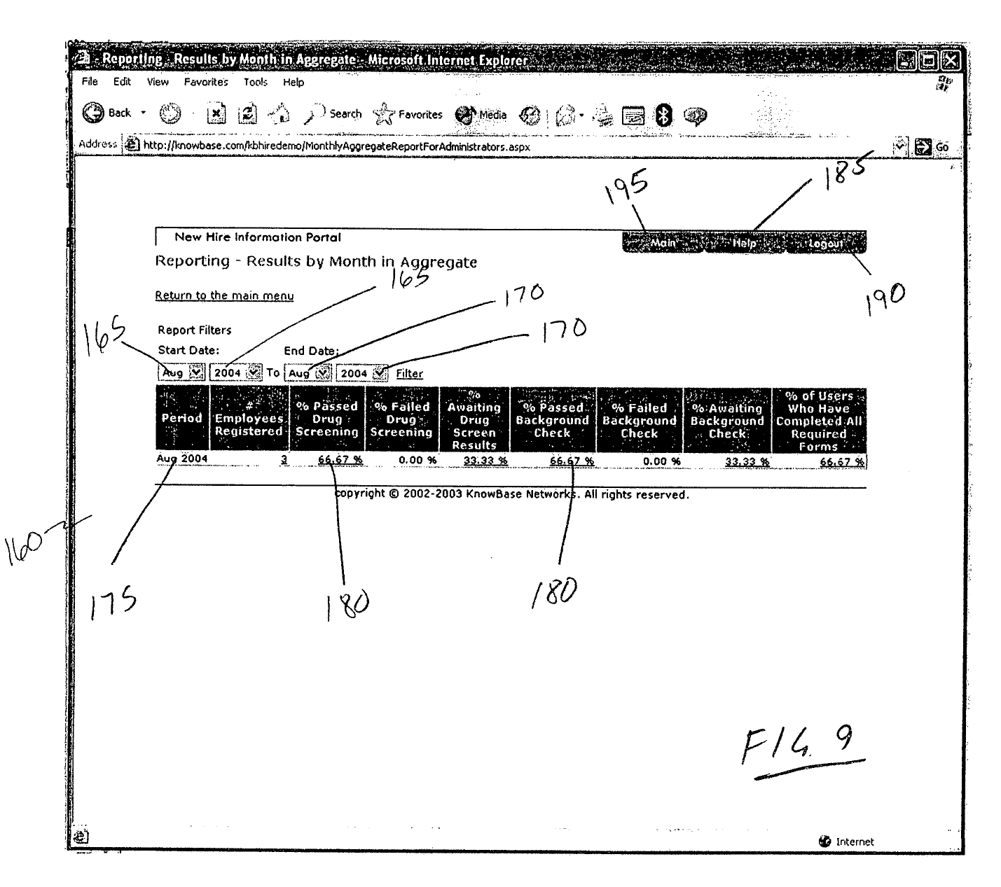

Referring now to FIG. 8 is a screen shot of a hiring manager manage employees screen 145 is disclosed. The screen shot of a hiring manager manage employees screen 145 presents the hiring manager with a list of potential employees undergoing hiring process 150. The list of potential employees undergoing hiring process 150 includes first status columns 155 envisioned to include such information as name, work location, phone number, date entered and the like. Editing of supplied information can be done from this screen by the hiring manager.

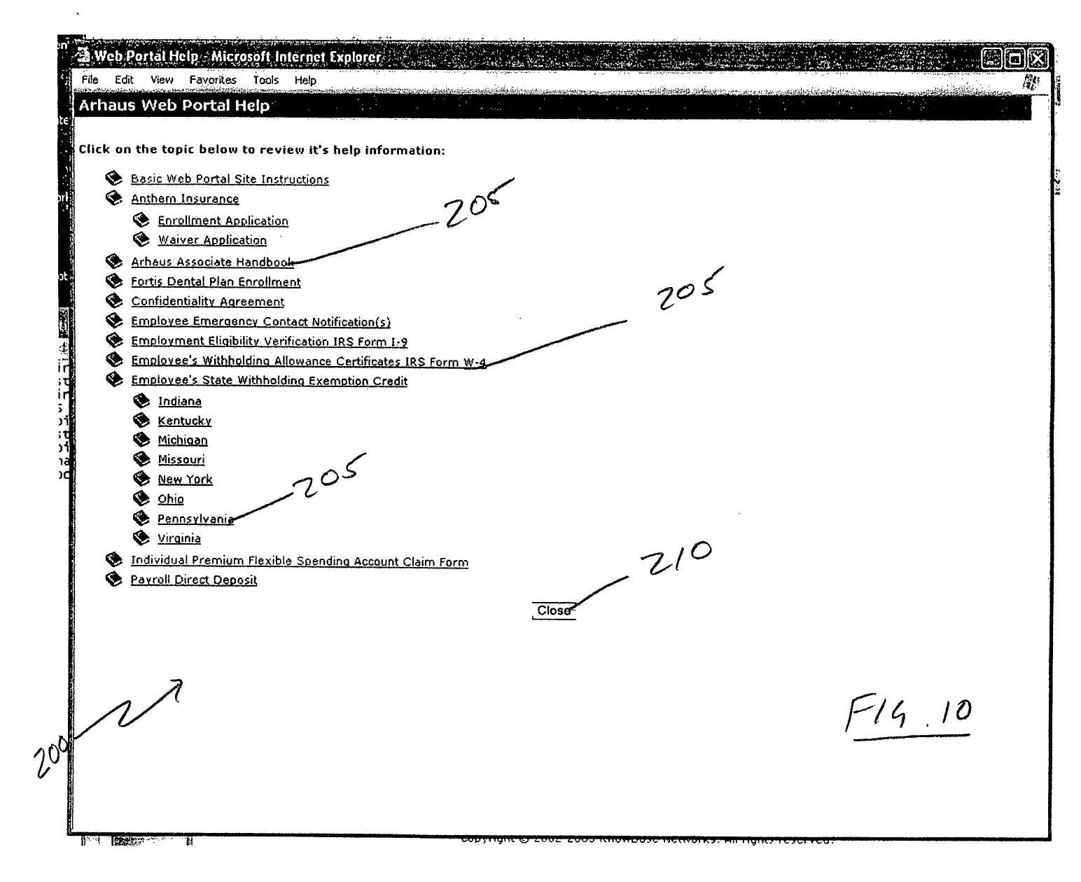

Referring next to FIG. 9 is a screen shot of a report test screen 160 is depicted. A first pull-down start date filter 165 and a first pull-down stop date filter 170 allow the user to customize the supplied report for a specific recording period. Once selected, a first reporting period 175 is provided with corresponding first reporting data fields 180 that provide data to the hiring manager. The specific first reporting data fields 180 can also be inquired upon directly to provide the specific data that comprises the corresponding first reporting data fields 180. It should be noted that the screen shot of a report test screen 160 as well as most previously described screens feature a first help button 185, a first logout button 190 and a first main menu button 195. Accessing the first main menu button 195 will return the user to the corresponding main menu for the type of user accessing the web based employee hiring management and tracking software 10. In the case of the hiring manager, he or she would be returned to the main menu selection screen for hiring manager 55 (as shown in FIG. 3)

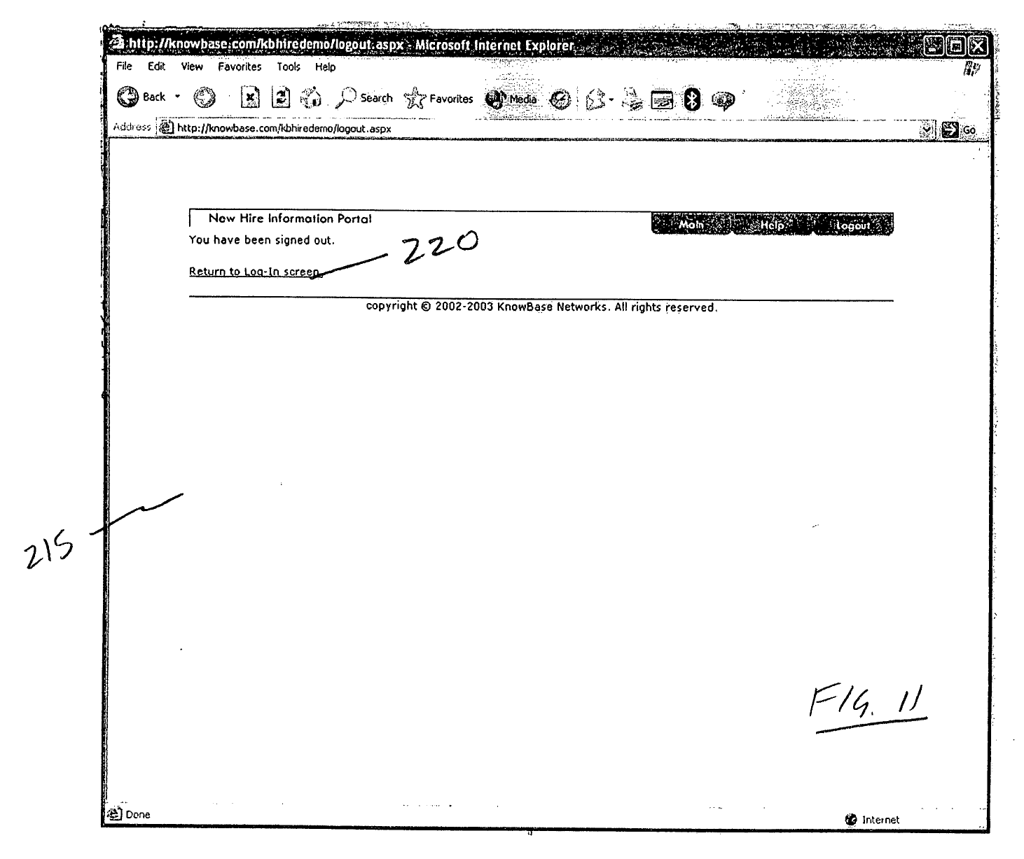

Referring now to FIG. 10, a screen shot of a hiring manager help screen 200 is depicted. The screen shot of a hiring manager help screen 200 is accessed whenever the user clicks upon the first help button 185 (as shown in FIG. 9) The screen shot of a hiring manager help screen 200 is envisioned as a new browser window that allows the user to access the supplied help functions and the main screens as previously described simultaneously. The screen shot of a hiring manager help screen 200 provides a plurality of first help topics 205 in the customary manner as well as a first close button 210 to allow the user to cease operation of the screen shot of a hiring manager help screen 200 as well.

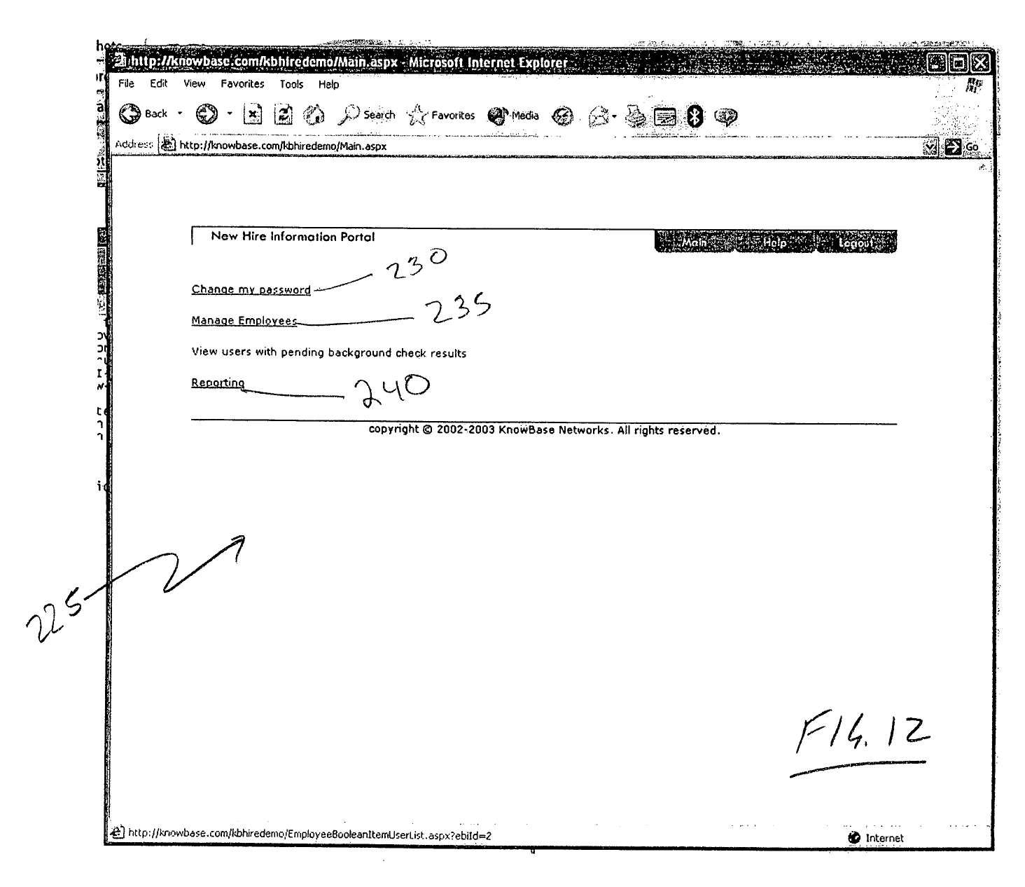

Referring now to FIG. 11, a screen shot of a hiring manager logout screen 215 is shown. The screen shot of a hiring manager logout screen 215 is accessed whenever the user clicks upon the first logout button 190 (as shown in FIG. 9). Such functionality allows the user to end the interactive session with the web based employee hiring management and tracking software 10. Should the user change his or her mind, or reach the screen shot of a hiring manager logout screen 215 by mistake, a first re-login button 220 is provided to allow the user to reconnect by redirecting the user to the screen shot of a main login screen 15 (as shown in FIG. 1)

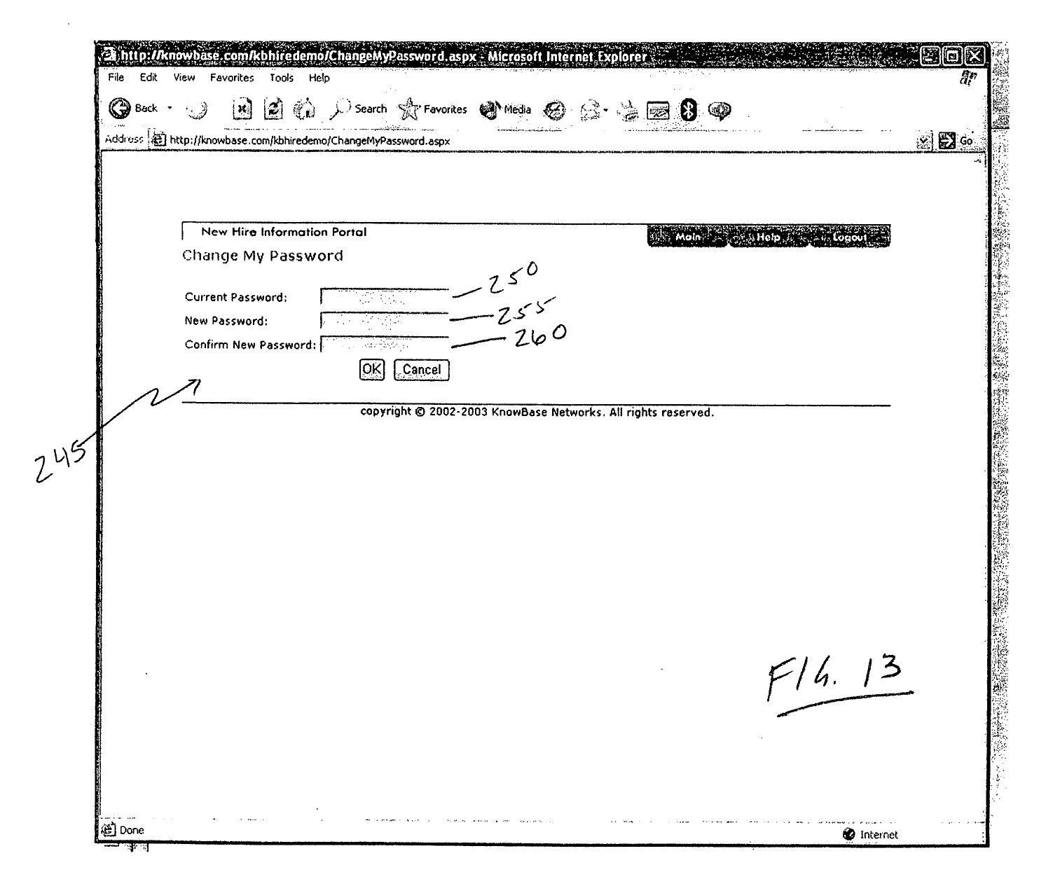

Referring next to FIG. 12, a screen shot of a main menu selection screen for background screening administrator 225 is depicted. Said screen is presented when a user provides a login and password associated with a background screening administrator at the screen shot of a main login screen 15 (as shown in FIG. 1). The screen shot of a main menu selection screen for background screening administrator 225 provides a first change my password button 230, a manage employees button 235 and a first reporting button 240.

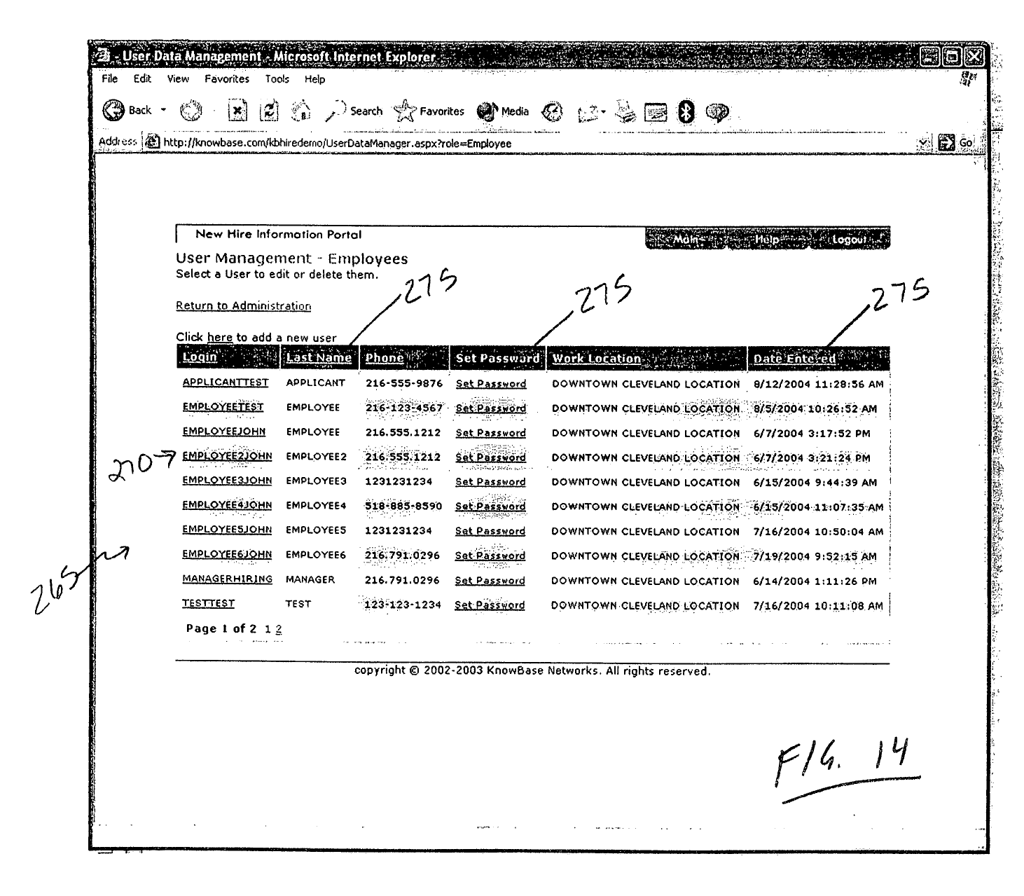

Referring now to FIG. 13, a screen shot of a background screening administrator password change screen 245 is presented. The screen shot of a background screening administrator password change screen 245 is presented upon activation of the first change my password button 230 (as shown in FIG. 12). A first current password field 250, a first new password field 255, and a first confirm password field 260 are presented in a customary manner to allow the user to change his or her password in an effort to maintain security and integrity of the database associated with the web based employee hiring management and tracking software 10.

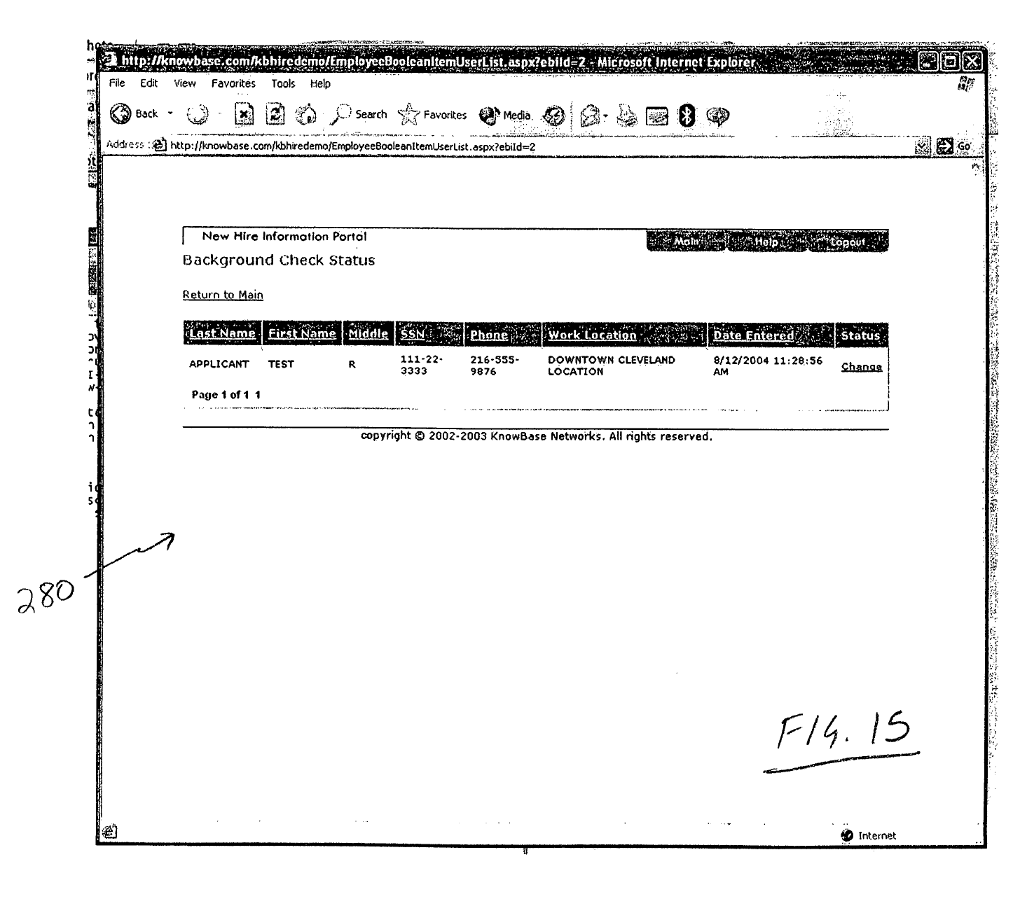

Referring next to FIG. 14, a screen shot of background screening administrators manage employees screen 265 is disclosed. The screen shot of background screening administrators manage employees screen 265 is presented upon activation of the manage employees button 235 (as shown in FIG. 2). The screen shot of background screening administrators manage employees screen 265 presents the background screen administrator with a list of potential employees undergoing background screening process 270. The list of potential employees undergoing background screening process 270 includes second status columns 275 envisioned to include such information as name, work location, phone number, date entered and the like. Editing of supplied information can be done from this screen by the background screening administrator.

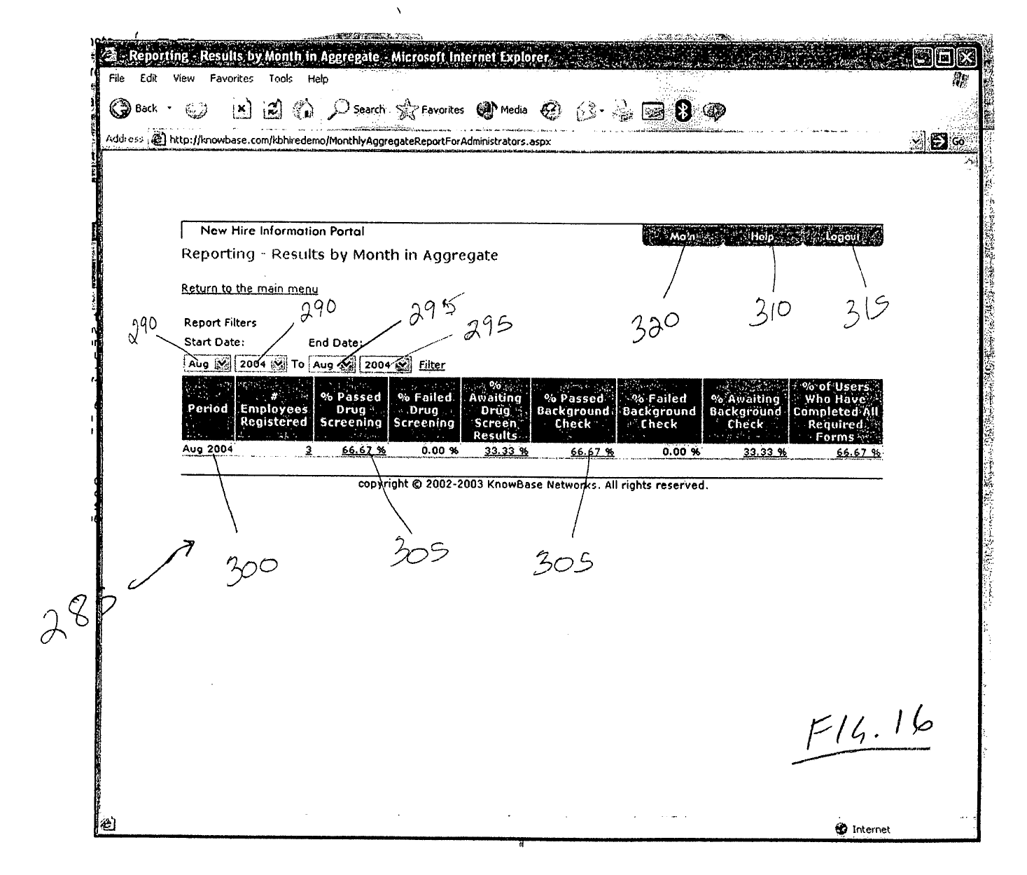

Referring now to FIG. 15, a screen shot of a users with pending background check results screen 280 is shown. The screen shot of a users with pending background check results screen 280 is presented to the background screen administrator whenever an actual applicant is selected from the list of potential employees undergoing background screening process 270 (as shown in FIG. 14). It is from the screen shot of a users with pending background check results screen 280 that information on screen results would be updated when such screening, investigation or test results become available.

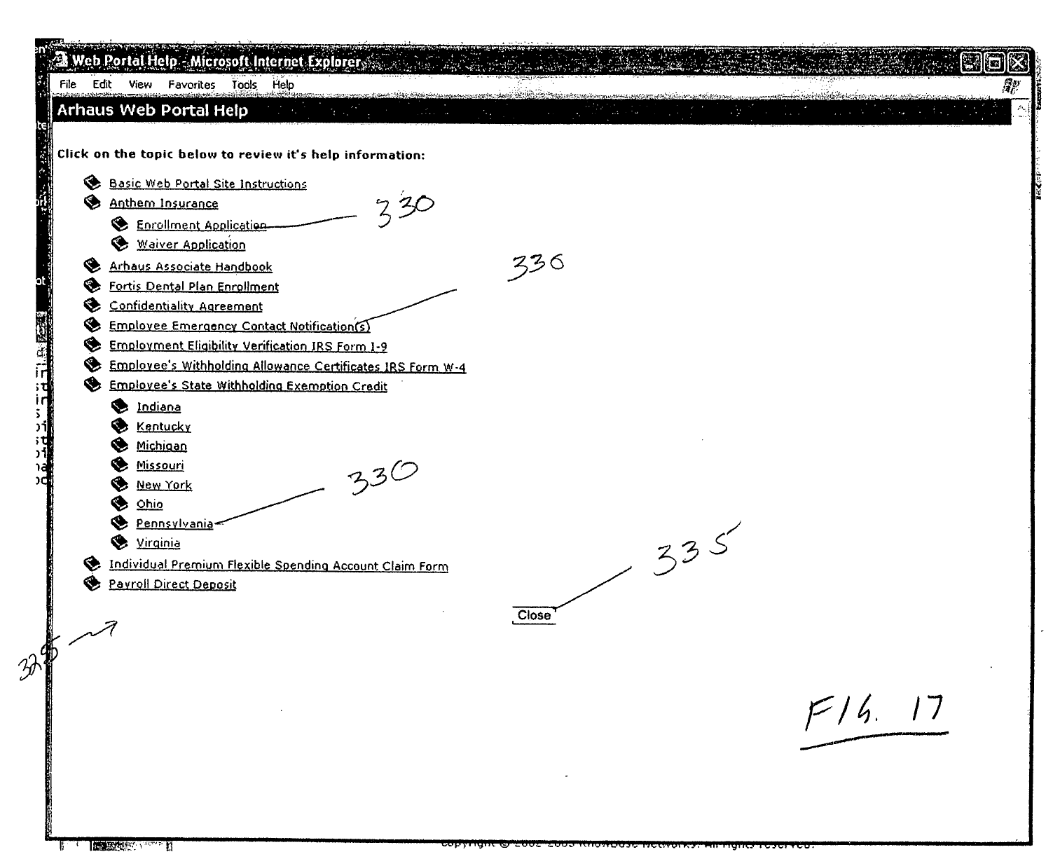

Referring next to FIG. 16, a screen shot of a background screening administrators reporting screen 285 is disclosed. A second pull-down start date filter 290 and a second pull-down stop date filter 295 allow the user to customize the supplied report for a specific recording period. Once selected, a second reporting period 300 is provided with corresponding second reporting data fields 305 that provide data to the background screening administrator. The specific second reporting data fields 305 can also be inquired upon directly to provide the specific data that comprises the corresponding second reporting data fields 305. It should be noted that the screen shot of a background screening administrators reporting screen 285 as well as most previously described screens feature a second help button 310, a second logout button 315 and a second main menu button 320. Accessing the second main menu button 320 will return the user to the corresponding main menu for the type of user accessing the web based employee hiring management and tracking software 10. In the case of the background screening administrator, he or she would be returned to the screen shot of a main menu selection screen for background screening administrator 225 (as shown in FIG. 12)

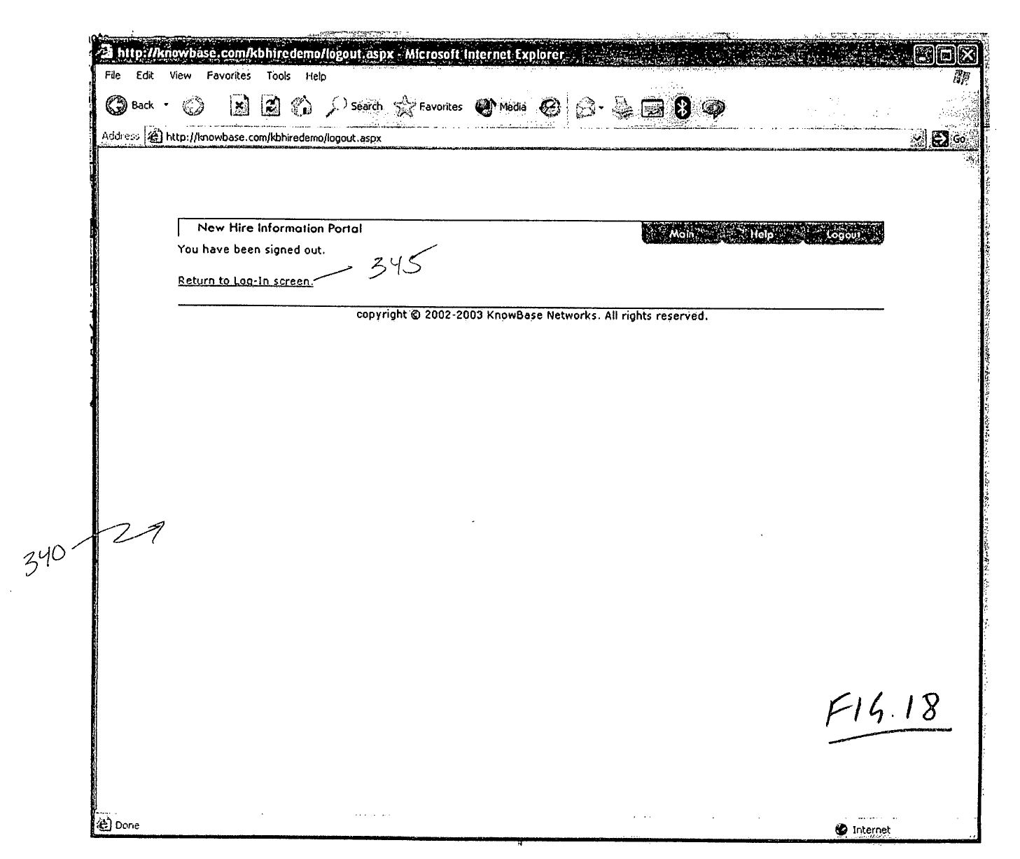

Referring now to FIG. 17, a screen shot of a background screening administrator help screen 325 is depicted. The screen shot of a background screening administrator help screen 325 is accessed whenever the user clicks upon the second help button 310 (as shown in FIG. 16) The screen shot of a background screening administrator help screen 325 is envisioned as a new browser window that allows the user to access the supplied help functions and the main screens as previously described simultaneously. The screen shot of a background screening administrator help screen 325 provides a plurality of second help topics 330 in the customary manner as well as a second close button 335 to allow the user to cease operation of the screen shot of a background screening administrator help screen 325 as well.

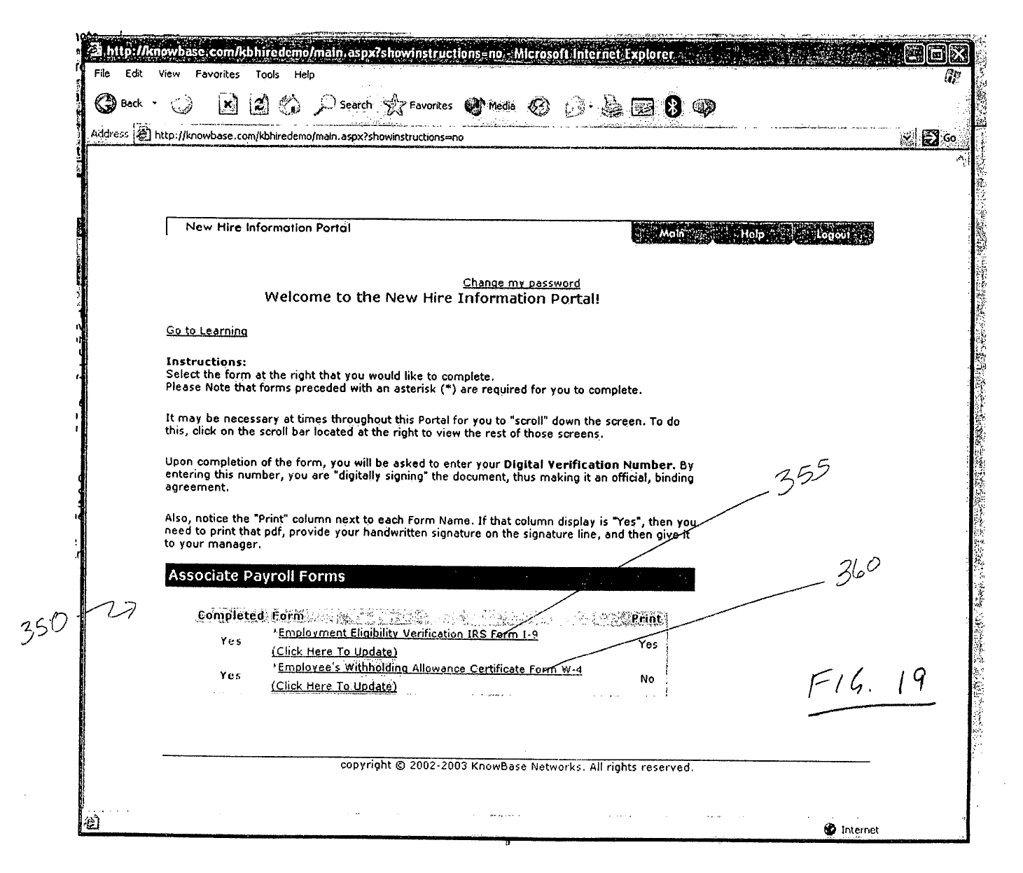

Referring now to FIG. 18, a screen shot of a background screening administrator logout screen 340 is shown. The screen shot of a background screening administrator logout screen 340 is accessed whenever the user clicks upon the second logout button 315 (as shown in FIG. 16). Such functionality allows the user to end the interactive session with the web based employee hiring management and tracking software 10. Should the user change his or her mind, or reach the screen shot of a background screening administrator logout screen 340 by mistake, a second re-login button 345 is provided to allow the user to reconnect by redirecting the user to the screen shot of a main login screen 15 (as shown in FIG. 1)

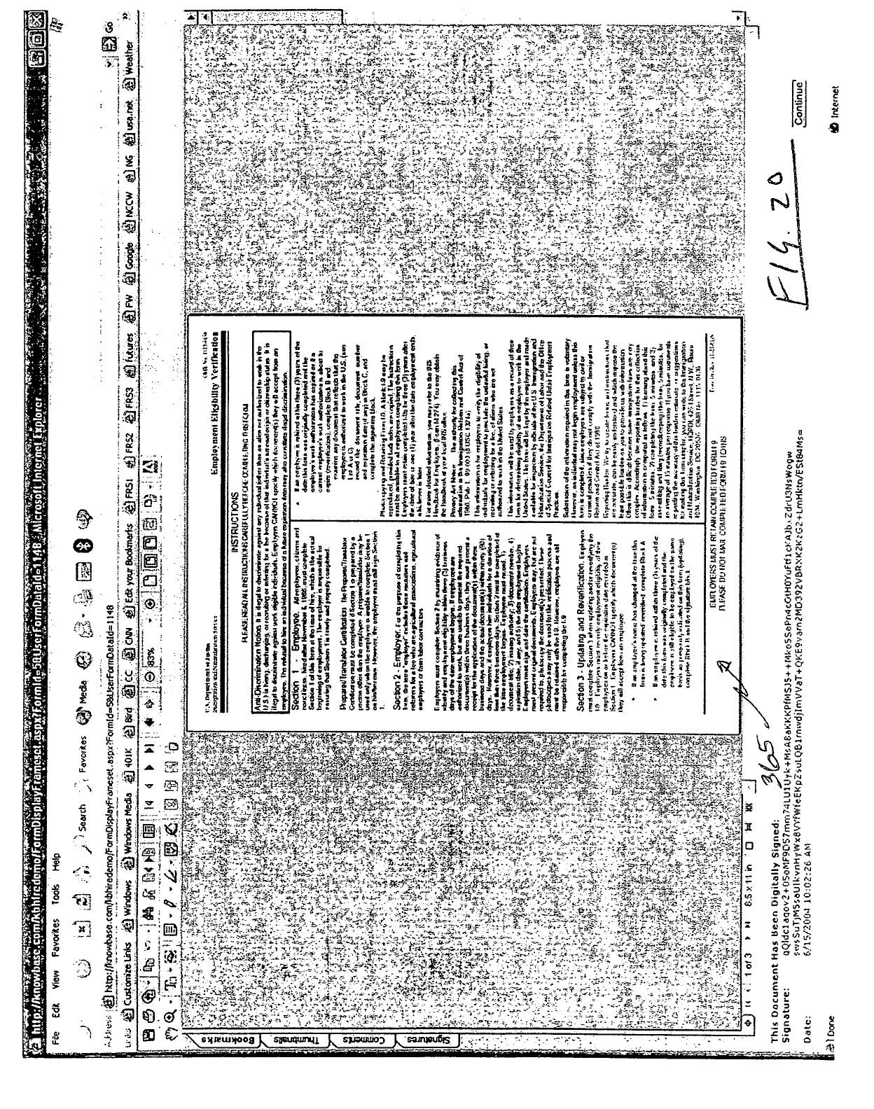

Referring next to FIG. 19, a screen shot of a main menu screen for the employee 350 is depicted. Said screen is presented when a user provides a login and password associated with an employee at the screen shot of a main login screen 15 (as shown in FIG. 1). The screen shot of a main menu screen for the employee 350 provides a access point for first selected form link 355, and a access point for second selected form link 360. It should be noted that while government forms I-9 and W4 are depicted in FIG. 19, any type or quantity of forms designed for new employees can be accommodated by the web based employee hiring management and tracking software 10, and as such, should not be considered a limiting factor of the web based employee hiring management and tracking software 10. Upon activation of either the access point for first selected form link 355 or the access point for second selected form link 360, the user or employee is presented with the opportunity to read and/or print the associated documents.

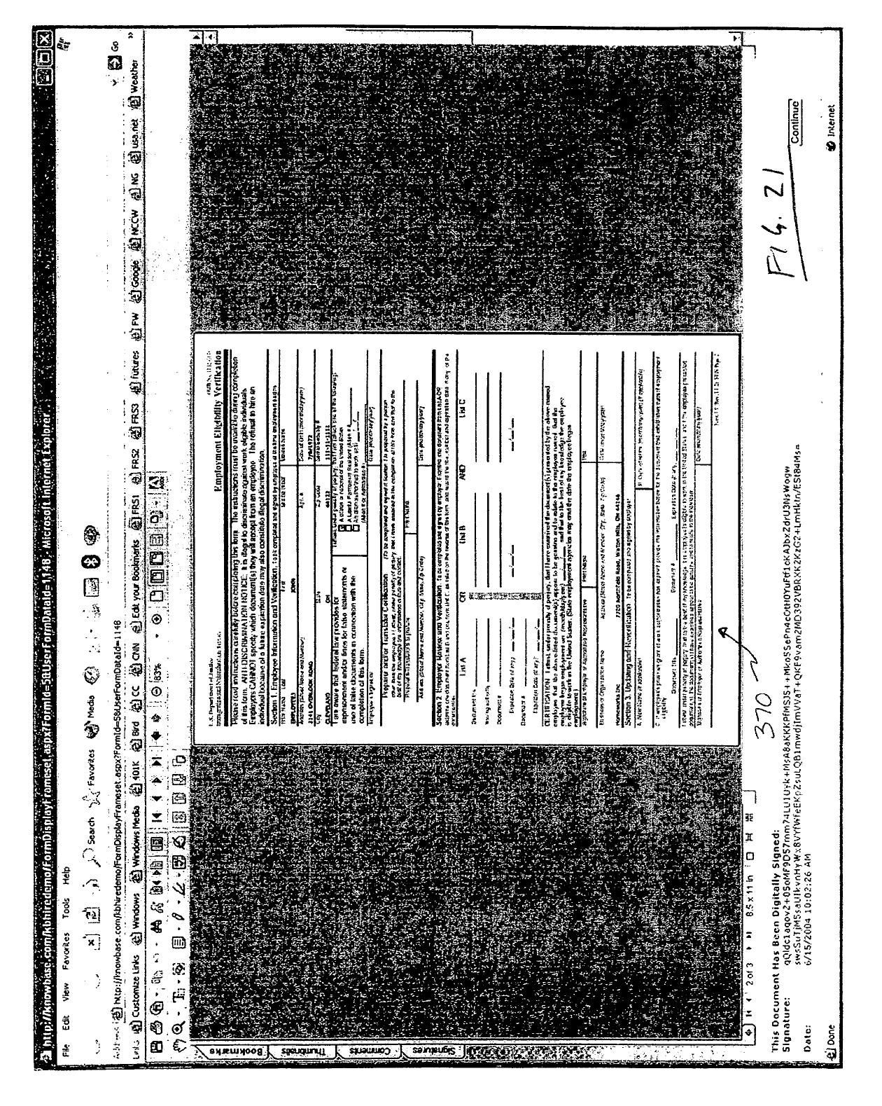

Referring now to FIG. 20, a screen shot of first page of first selected form 365 is shown. The screen shot of first page of first selected form 365 is displayed as a result of the user selecting the access point for first selected form link 355 (as shown in FIG. 19).

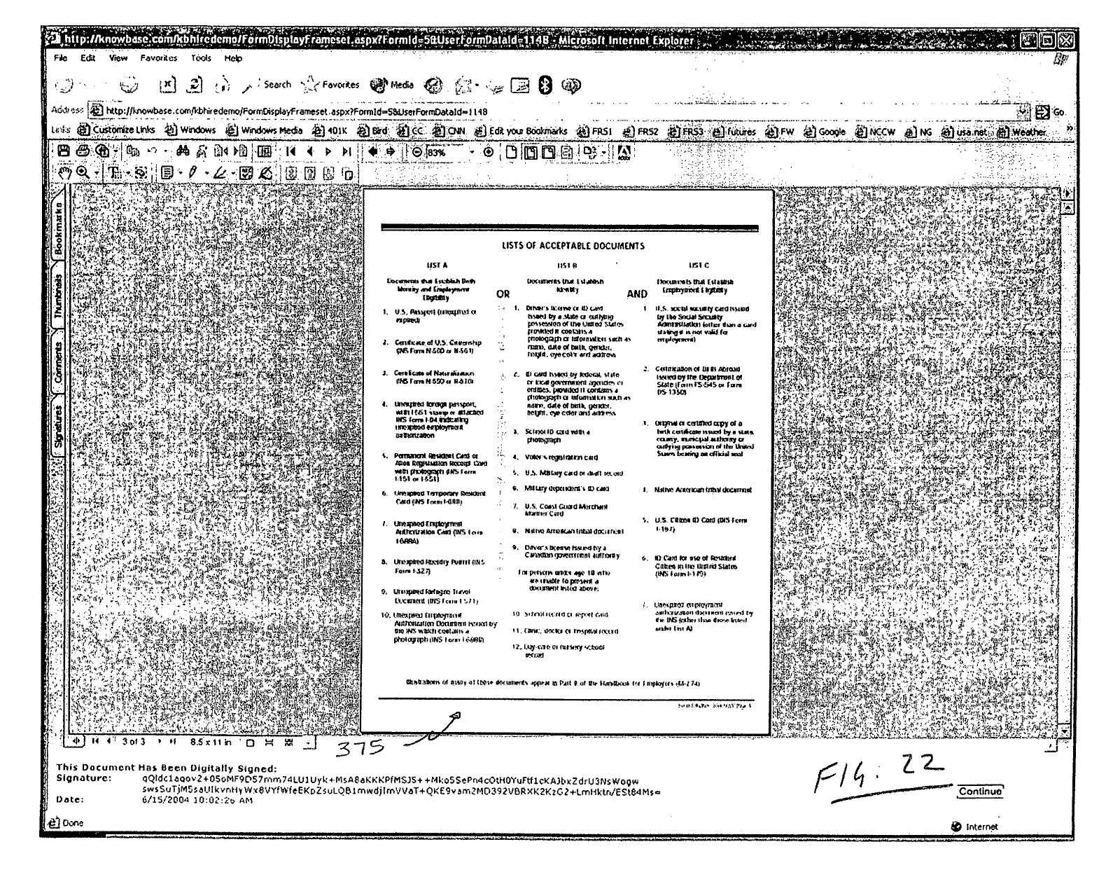

Referring next to FIG. 21, a screen shot of second page of first selected form 370 is depicted. The screen shot of second page of first selected form 370 is displayed as result of the user selecting the access point for first selected form link 355 (as shown in FIG. 19).

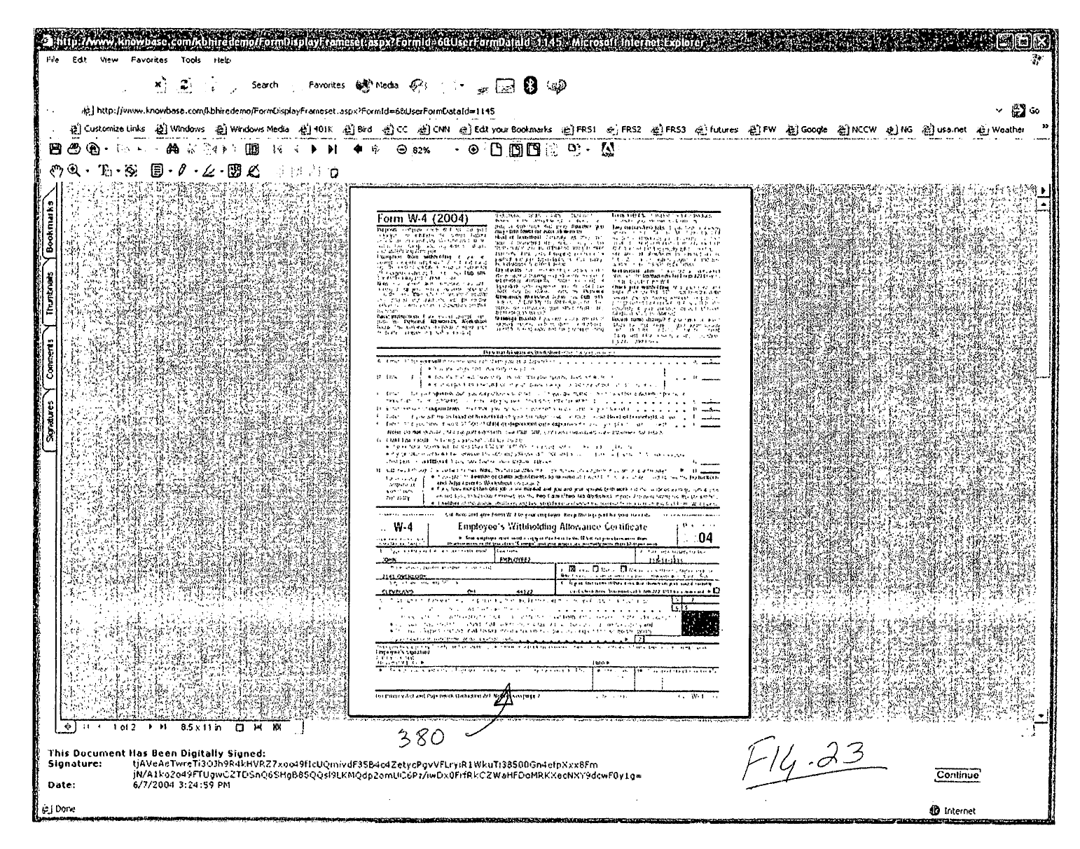

Referring now to FIG. 22, a screen shot of third page of first selected form 375 is disclosed. The screen shot of third page of first selected form 375 is displayed as a result of the user selecting the instruction screen for hiring manager 35 (as shown in FIG. 19).

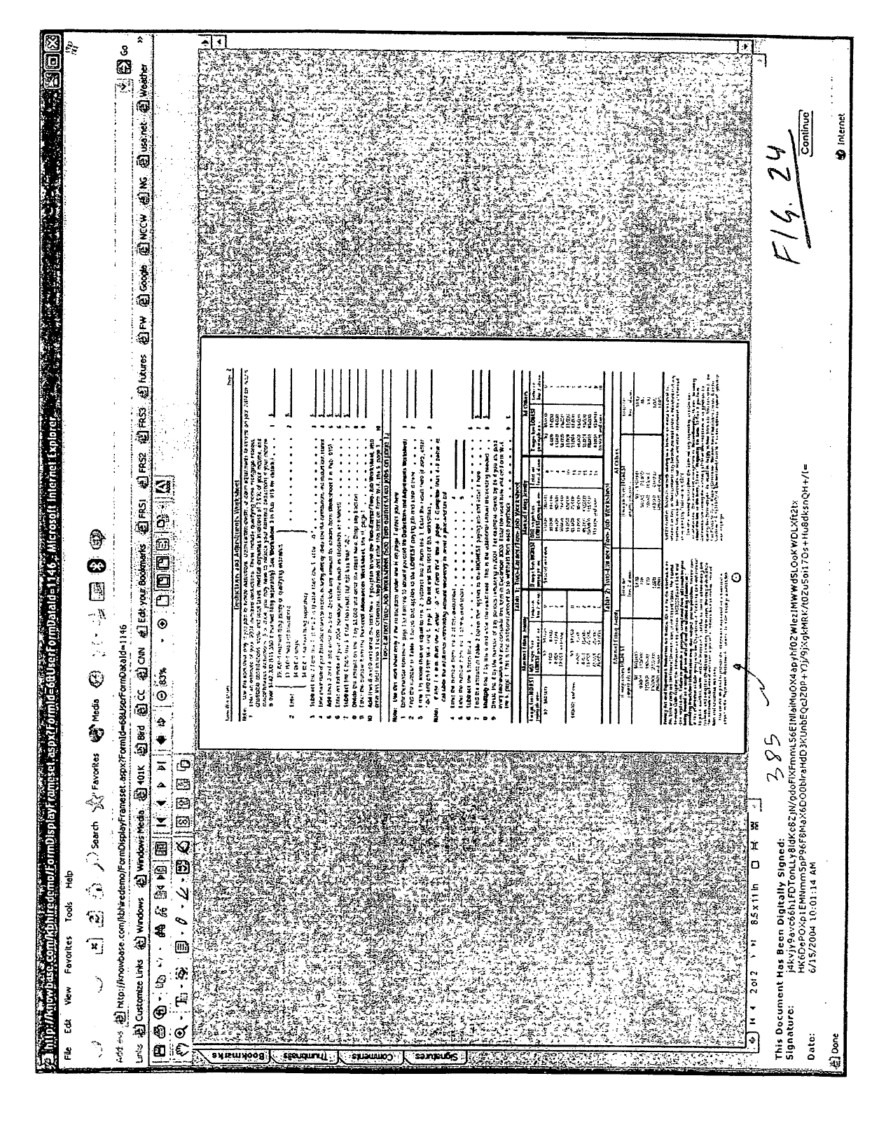

Referring now to FIG. 23, a screen shot of first page of second selected form 380 is shown. The screen shot of first page of second selected form 380 is displayed as a result of the user selecting the access point for second selected form link 360 (as shown in FIG. 19).

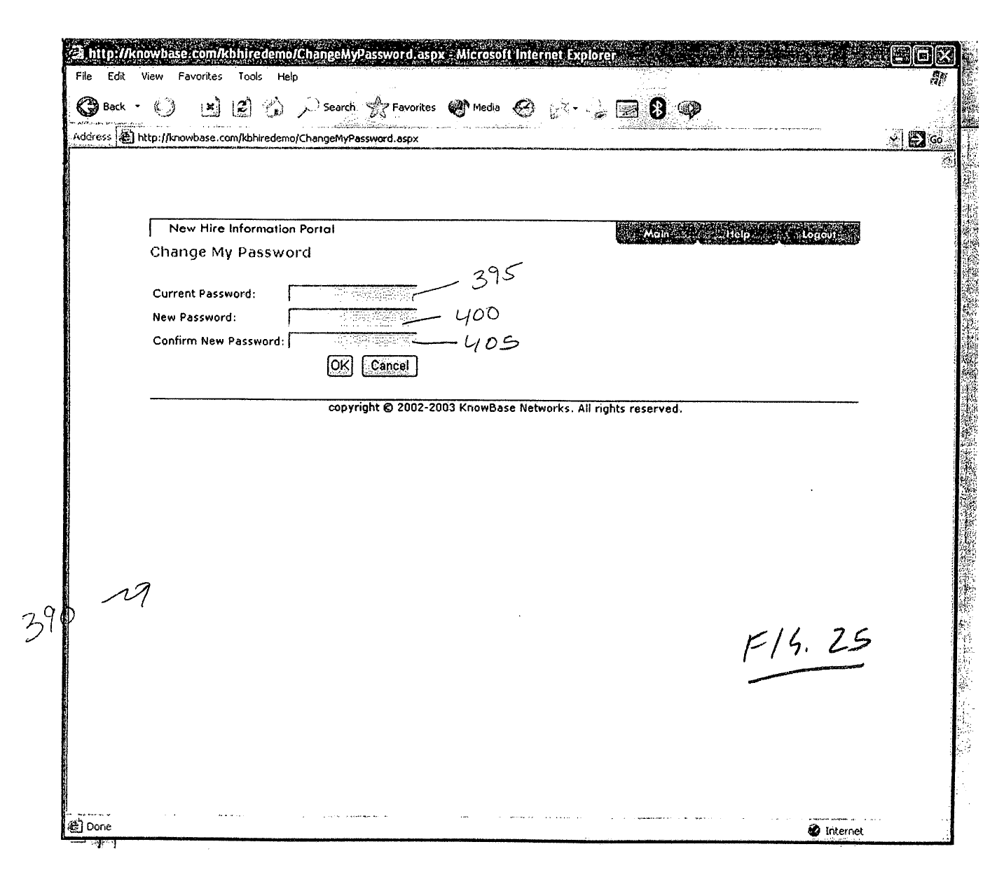

Referring next to FIG. 24, a screen shot of second page of second selected form 385 is depicted. The screen shot of second page of second selected form 385 is displayed as result of the user selecting the access point for second selected form link 360 (as shown in FIG. 19).

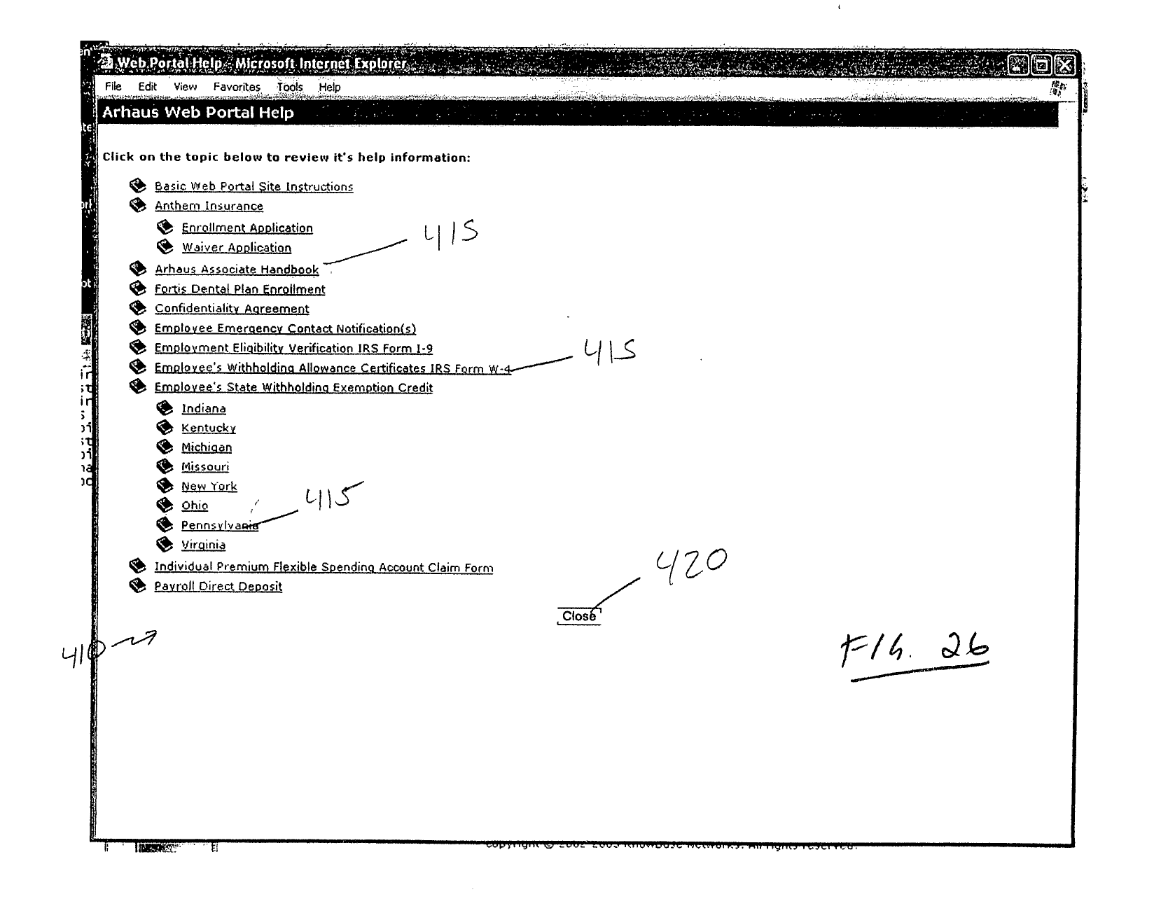

Referring now to FIG. 25, a screen shot of a employee password change screen 390 is presented. The screen shot of a employee password change screen 390 is presented upon activation of the associated icon as shown in FIG. 19. A second current password field 395, a second new password field 400, and a second confirm password field 405 are presented in a customary manner to allow the user to change his or her password in an effort to maintain security and integrity of the database associated with the web based employee hiring management and tracking software 10.

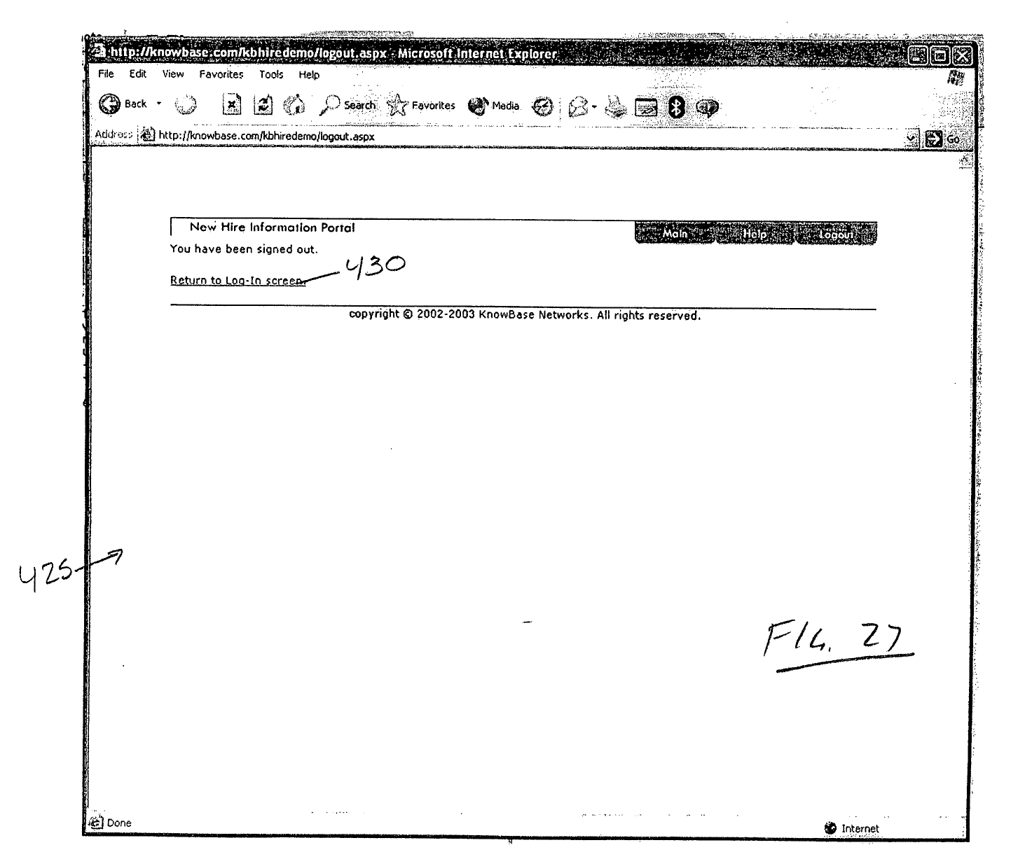

Referring now to FIG. 26, a screen shot of an employee help screen 410 is depicted. The screen shot of an employee help screen 410 is accessed whenever the user clicks upon the associated icon as shown in FIG. 19. The screen shot of an employee help screen 410 is envisioned as a new browser window that allows the user to access the supplied help functions and the main screens as previously described simultaneously. The screen shot of an employee help screen 410 provides a plurality of third topics 415 in the customary manner as well as a third close button 420 to allow the user to cease operation of the screen shot of an employee help screen 410 as well.

Referring now to FIG. 27, a screen shot of an employee logout screen 425 is shown. The screen shot of an employee logout screen 425 is accessed whenever the user clicks upon the associated icon as shown in FIG. 19. Such functionality allows the user to end the interactive session with the web based employee hiring management and tracking software 10. Should the user change his or her mind, or reach the screen shot of an employee logout screen 425 by mistake, a third re-login button 430 is provided to allow the user to reconnect by redirecting the user to the screen shot of a main login screen 15 (as shown in FIG. 1)

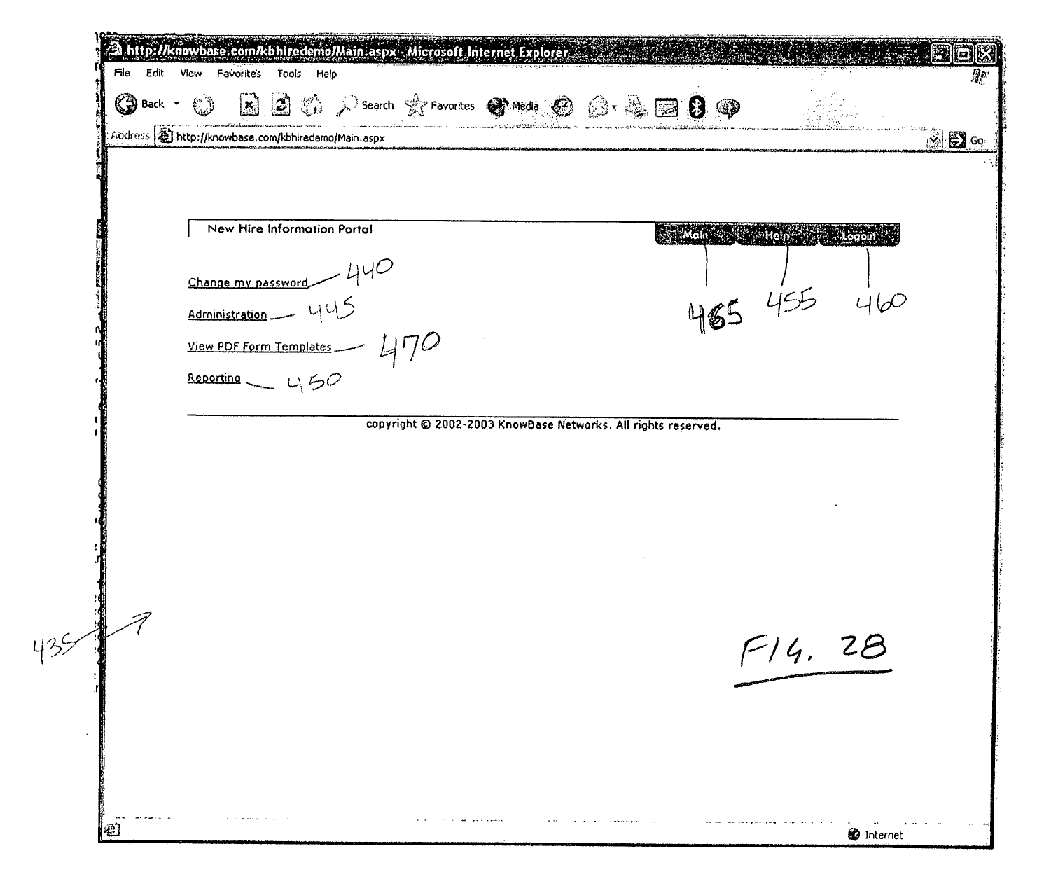

Referring next to FIG. 28, a screen shot of a main menu selection screen for the human resource administrator 435 is depicted. Said screen is presented when a user provides a login and password associated with a human resource (HR) administrator at the screen shot of a main login screen 15 (as shown in FIG. 1). The screen shot of a main menu selection screen for the human resource administrator 435 provides a second change my password button 440 for the purposes of changing their password. It also has a administrative control button 445 for the purposes of displaying an administrative menu. It also has a second reporting button 450 for the option of displaying various reports. It also has a third help button 455, a third logout button 460 and a third main menu button 465 for the purposes of displaying a help menu, for the purposes of logging out, and for the purposes of returning to the main menu respectively. Finally, a view template button 470 is provided to allow the user or human resource administrator to view various form templates in their native format, such as would appear during a printing operation.

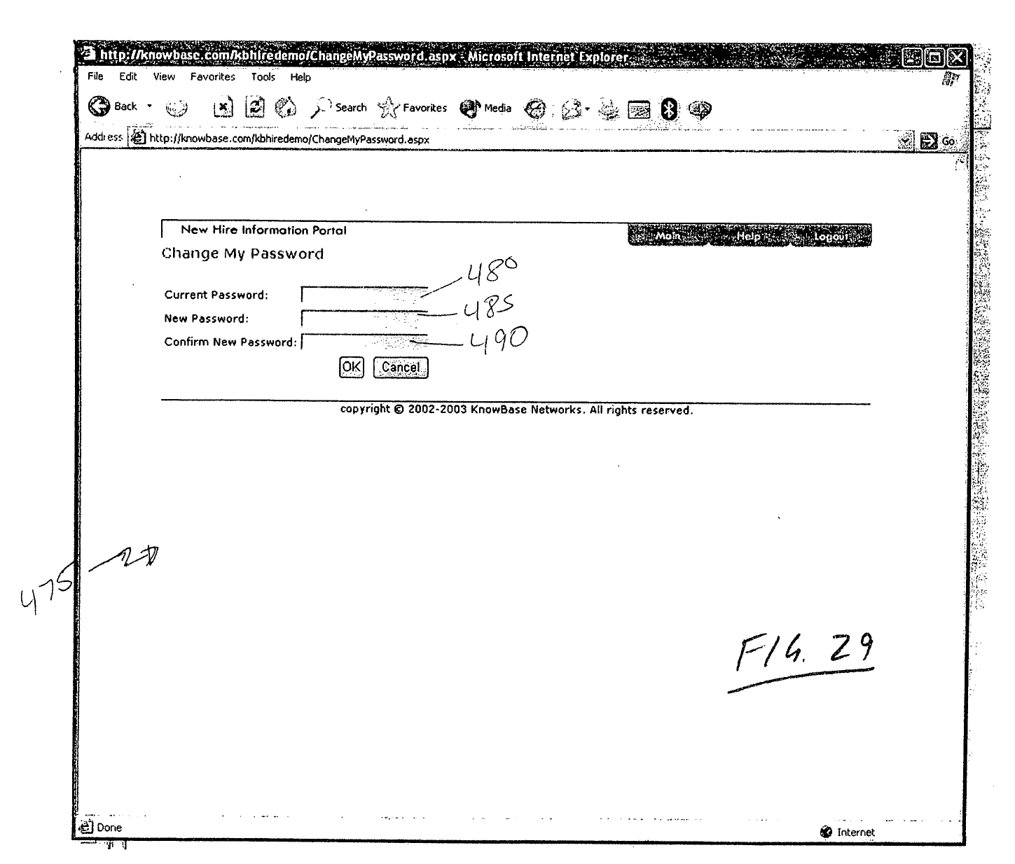

Referring now to FIG. 29, a screen shot of a human resource administrator password change screen 475 is presented. The screen shot of a human resource administrator password change screen 475 is presented upon activation of the second change my password button 440 (as shown in FIG. 28). A third current password field 480, a third new password field 485, and a third confirm password field 490 are presented in a customary manner to allow the user to change his or her password in an effort to maintain security and integrity of the database associated with the web based employee hiring management and tracking software 10.

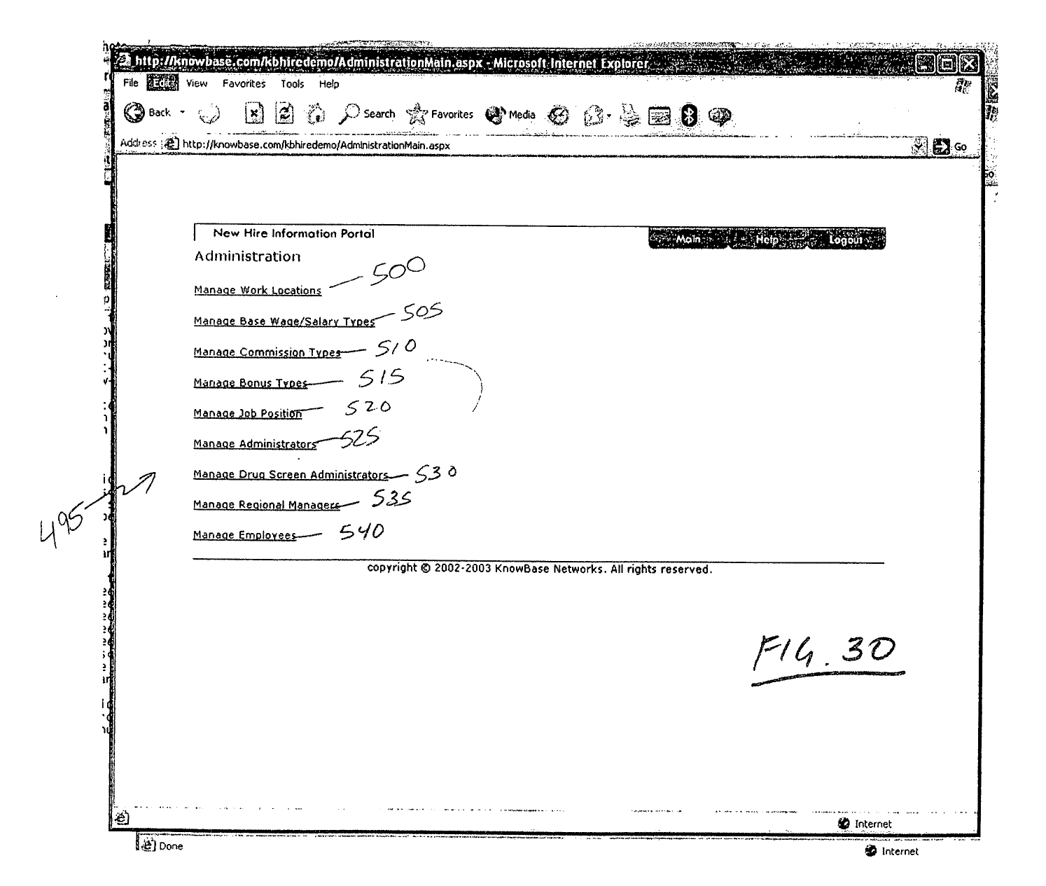

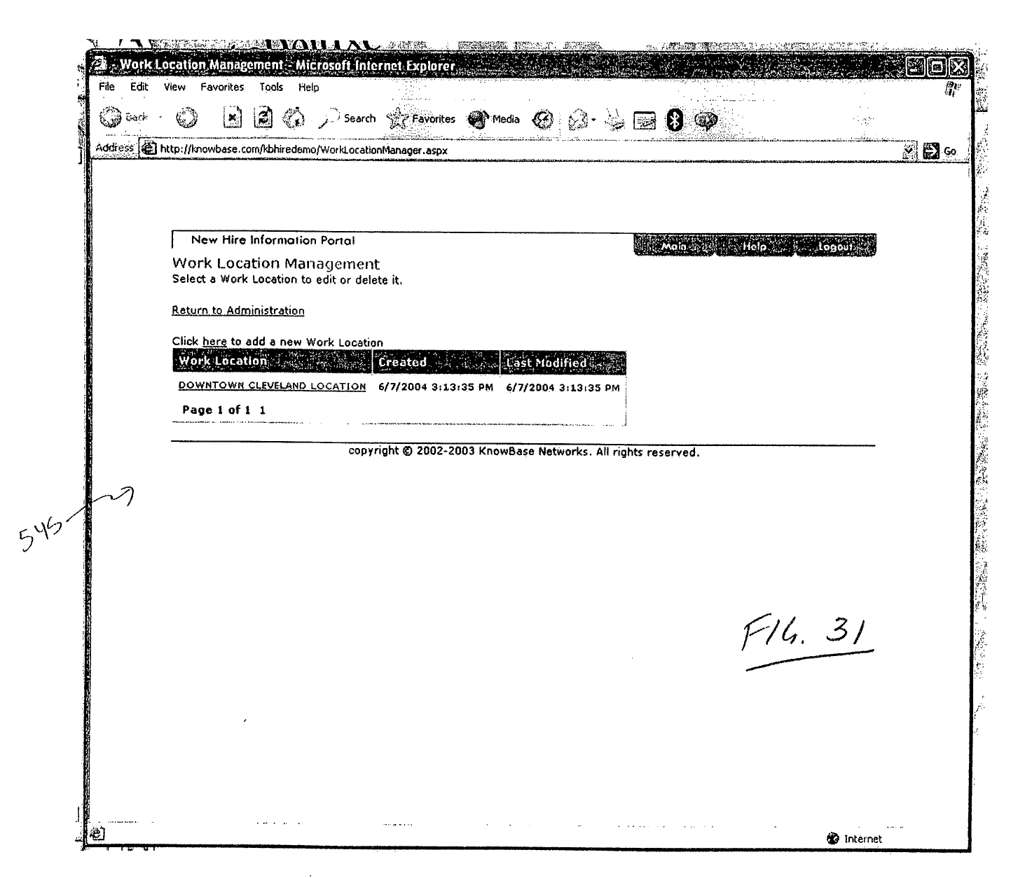

Referring now to FIG. 30, a screen shot of a administration menu screen for the human resource administrator 495 is depicted. The screen shot of a administration menu screen for the human resource administrator 495 provides the human resource administrator access to a variety of screens that can be used to control the various job descriptions, compensation programs, managerial functions, and the like for various future and current hire employees. The functions administered by the screen shot of a administration menu screen for the human resource administrator 495 will vary per the specific organization using the web based employee hiring management and tracking software 10, so a possible selection of functions are displayed here for illustrative purposes. Such that said functions can vary in quantity and type, said functions are not intended to be a limiting factor of the present invention. The displayed function of the screen shot of a administration menu screen for the human resource administrator 495 are a manage work locations button 500, which gives the human resource administrator to a subsequent screen which allows changes to the various work place descriptions that may be serviced by an organization, a manage base wage/salary types button 505, which gives the human resource administrator to a subsequent screen which allows changes to the various base wages and salary types for various new employees, a manage commission types button 510, which gives the human resource administrator to a subsequent screen which allows changes to the commission types that may be offered to various new employees, a manage bonus types button 515, which gives the human resource administrator to a subsequent screen which allows changes to various bonus types which may be offered to new employees, a manage job position button 520 which gives the human resource administrator to a subsequent screen which allows changes to various job positions which may be offered to new employees, a manage administrators button 525 which gives the human resource administrator to a subsequent screen which allows changes to the administrators who may access the web based employee hiring management and tracking software 10, a manage drug screen administrators button 530, which gives the human resource administrator to a subsequent screen which allows changes to the drug screening administrators who may access the web based employee hiring management and tracking software 10, a manage regional managers button 535, which gives the human resource administrator to a subsequent screen which allows changes to the regional manners who may access the web based employee hiring management and tracking software 10, and finally a manage employees button 540, which gives the human resource administrator to a subsequent screen which allows changes to the employees who comprise the main database of the web based employee hiring management and tracking software 10.

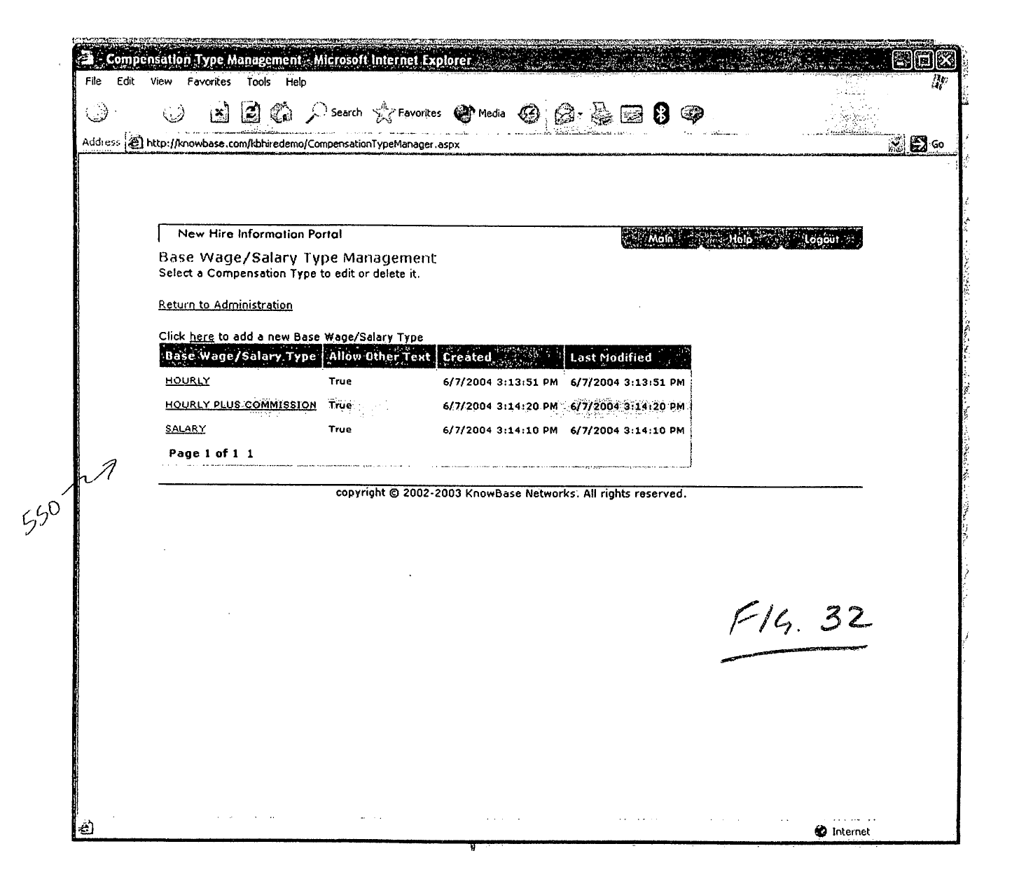

Referring next to FIG. 31, a screen shot of a work location screen for the human resource administrator 545 is described. The screen shot of a work location screen for the human resource administrator 545 is produced by the web based employee hiring management and tracking software 10 when the user selects the manage work locations button 500 (as shown in FIG. 30). The screen shot of a work location screen for the human resource administrator 545 would be used to administer various work locations in the case of a multiple location organization.

Referring now to FIG. 32, a screen shot of a manage Base Wage/Salary Types for the human resource administrator 550 is disclosed. The screen shot of a manage Base Wage/Salary Types for the human resource administrator 550 is produced by the web based employee hiring management and tracking software 10 when the user selects the manage base wage/salary types button 505 (as shown in FIG. 30). The screen shot of a manage Base Wage/Salary Types for the human resource administrator 550 would be used to administer the various types of compensation as offered to new employees.

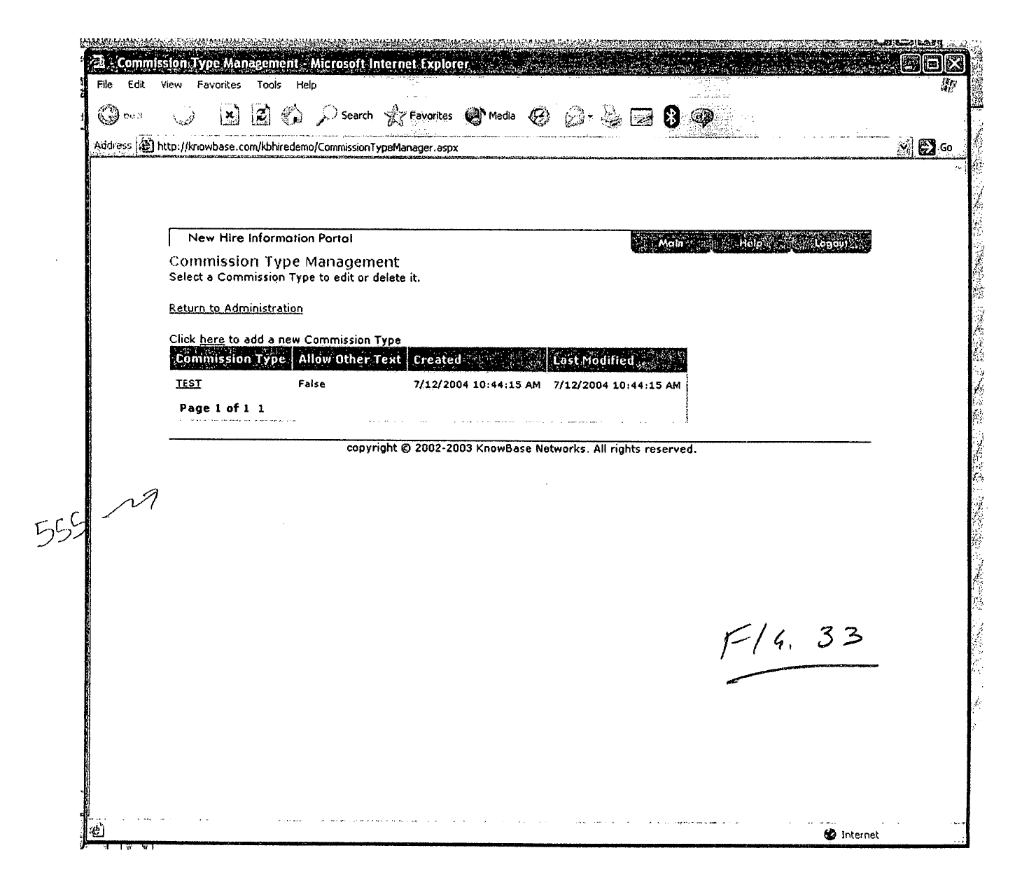

Referring now to FIG. 33, a screen shot of a manage Commission Types screen for the human resource administrator 555 is shown. The screen shot of a manage Commission Types screen for the human resource administrator 555 is produced by the web based employee hiring management and tracking software 10 when the user selects the manage commission types button 510 (as shown in FIG. 30). The screen shot of a manage Commission Types screen for the human resource administrator 555 would be used to administer the various types of commission as offered to new employees.

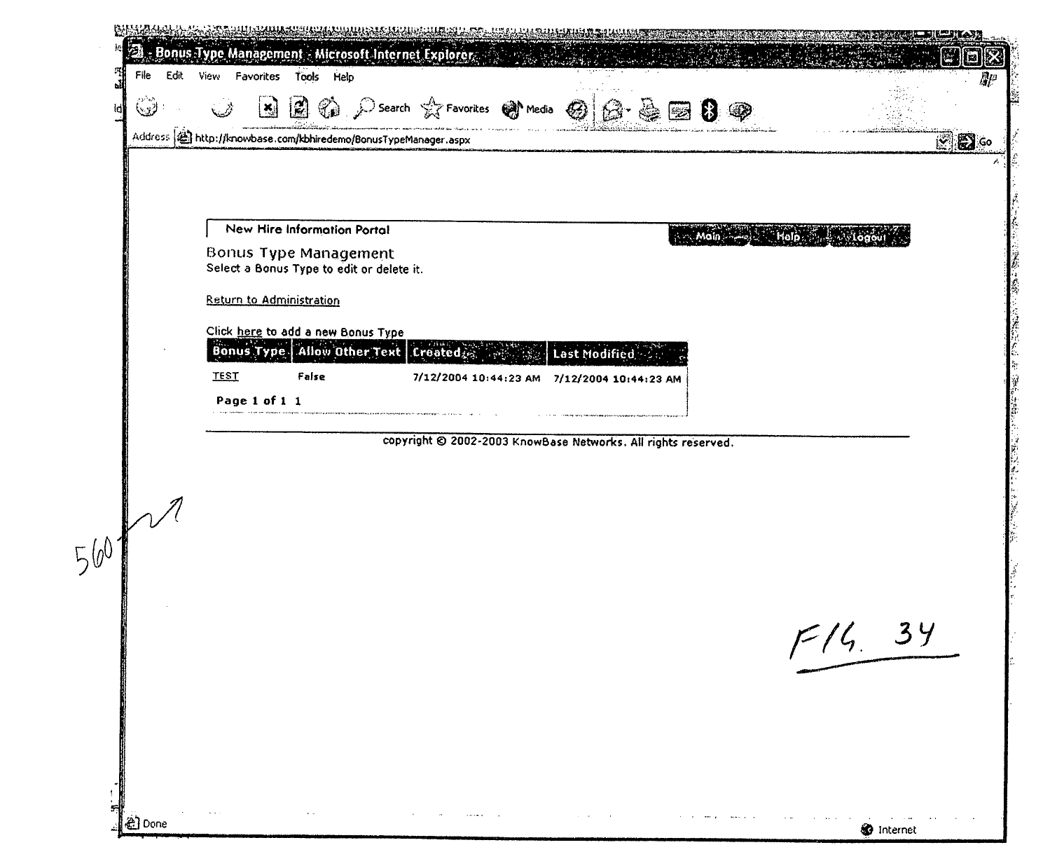

Referring next to FIG. 34, a screen shot of a manage bonus types screen for the human resource administrator 560, is disclosed. The screen shot of a manage bonus types screen for the human resource administrator 560 is produced by the web based employee hiring management and tracking software 10 when the user selects the manage bonus types button 515 (as shown in FIG. 30). The screen shot of a manage bonus types screen for the human resource administrator 560 would be used to administer the various types of bonuses as available to new employees.

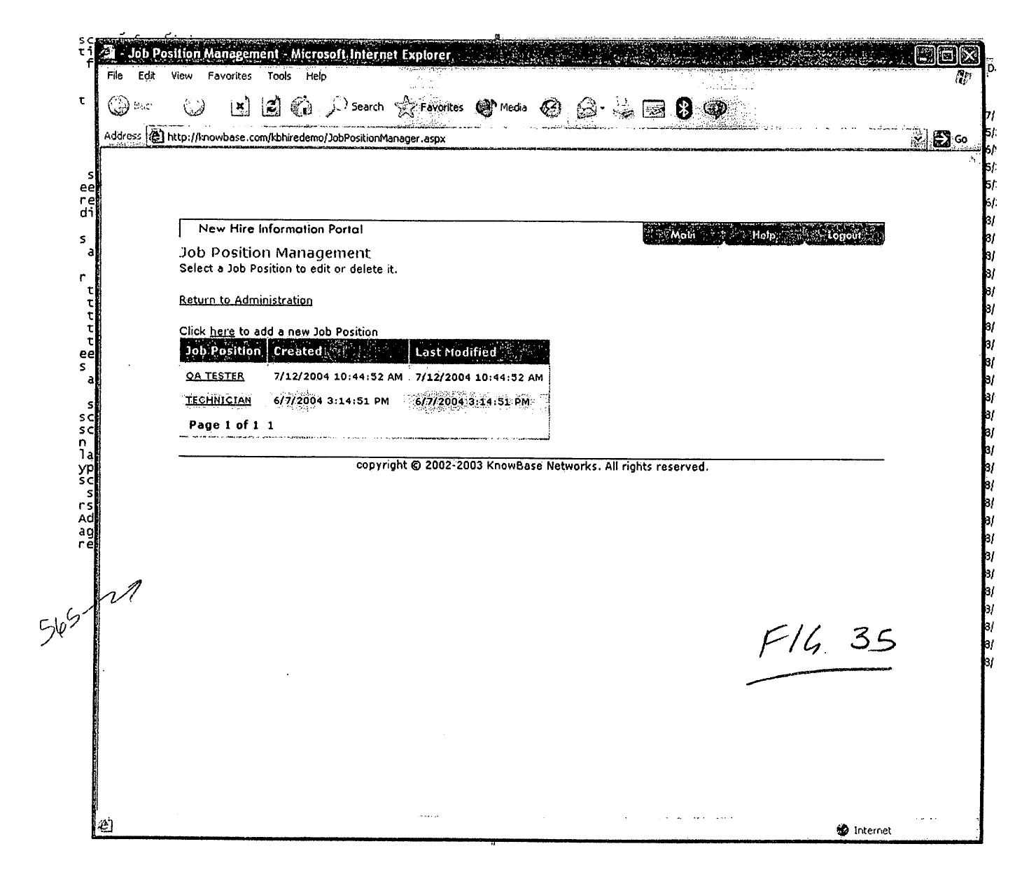

Referring now to FIG. 35, a screen shot of a manage job position screen for the human resource administrator 565 is depicted. The screen shot of a manage job position screen for the human resource administrator 565 is produced by the web based employee hiring management and tracking software 10 when the user selects the manage job position button 520 (as shown in FIG. 30). The screen shot of a manage job position screen for the human resource administrator 565 would be used to administer the various types of job positions as made available to new employees.

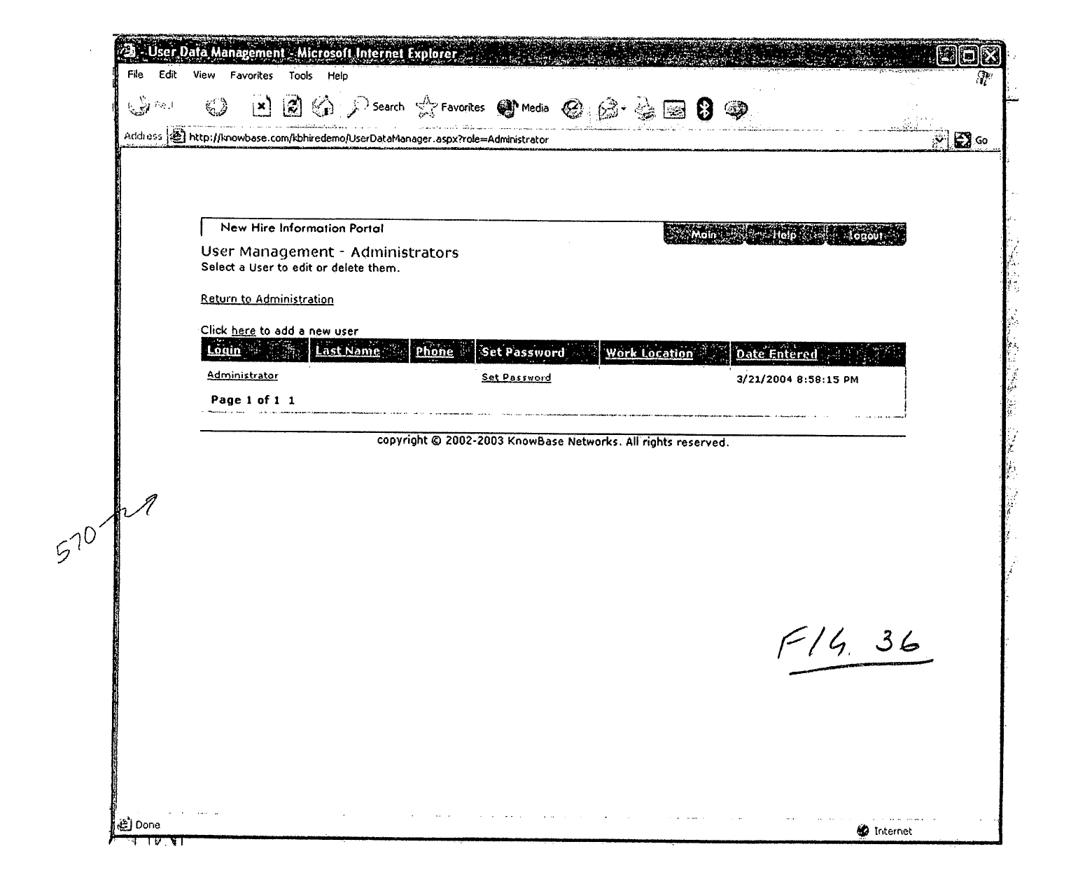

Referring next to FIG. 36, a screen shot of a manage administrators screen for the human resource administrator 570 is shown. The screen shot of a manage administrators screen for the human resource administrator 570 is produced by the web based employee hiring management and tracking software 10 when the user selects the manage administrators button 525 (as shown in FIG. 30). The screen shot of a manage administrators screen for the human resource administrator 570 would be used to add, delete or edit the various administrators allowed to access the web based employee hiring management and tracking software 10.

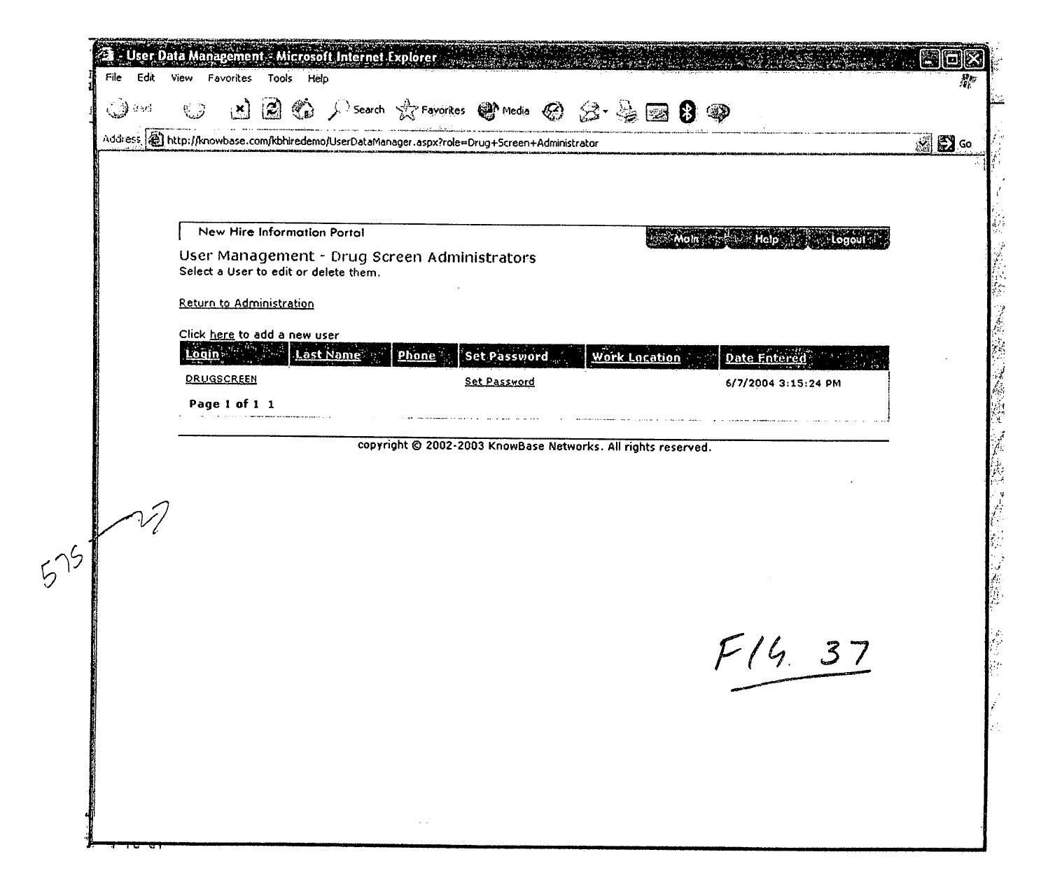

Referring now to FIG. 37, a screen shot of a manage drug screen administrators screen for the human resource administrator 575 is disclosed. The screen shot of a manage drug screen administrators screen for the human resource administrator 575 is produced by the web based employee hiring management and tracking software 10 when the user selects the manage drug screen administrators button 530 (as shown in FIG. 30). The screen shot of a manage drug screen administrators screen for the human resource administrator 575 would be used to add, delete or edit the various drug screen administrators allowed to access the web based employee hiring management and tracking software 10.

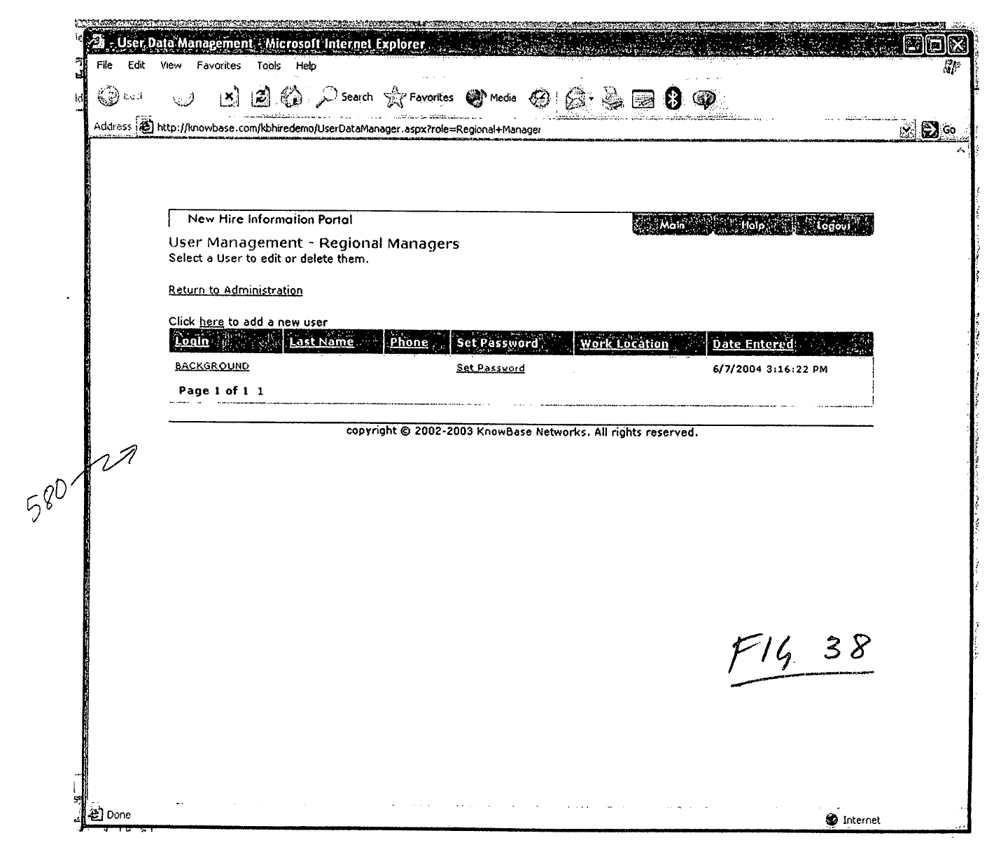

Referring now to FIG. 38, a screen shot of a manage regional managers screen for the human resource administrator 580 is depicted. The screen shot of a manage regional managers screen for the human resource administrator 580 is produced by the web based employee hiring management and tracking software 10 when the user selects the manage regional managers button 535 (as shown in FIG. 30). The screen shot of a manage regional managers screen for the human resource administrator 580 would be used to add, delete or edit the various regional managers allowed to access the web based employee hiring management and tracking software 10.

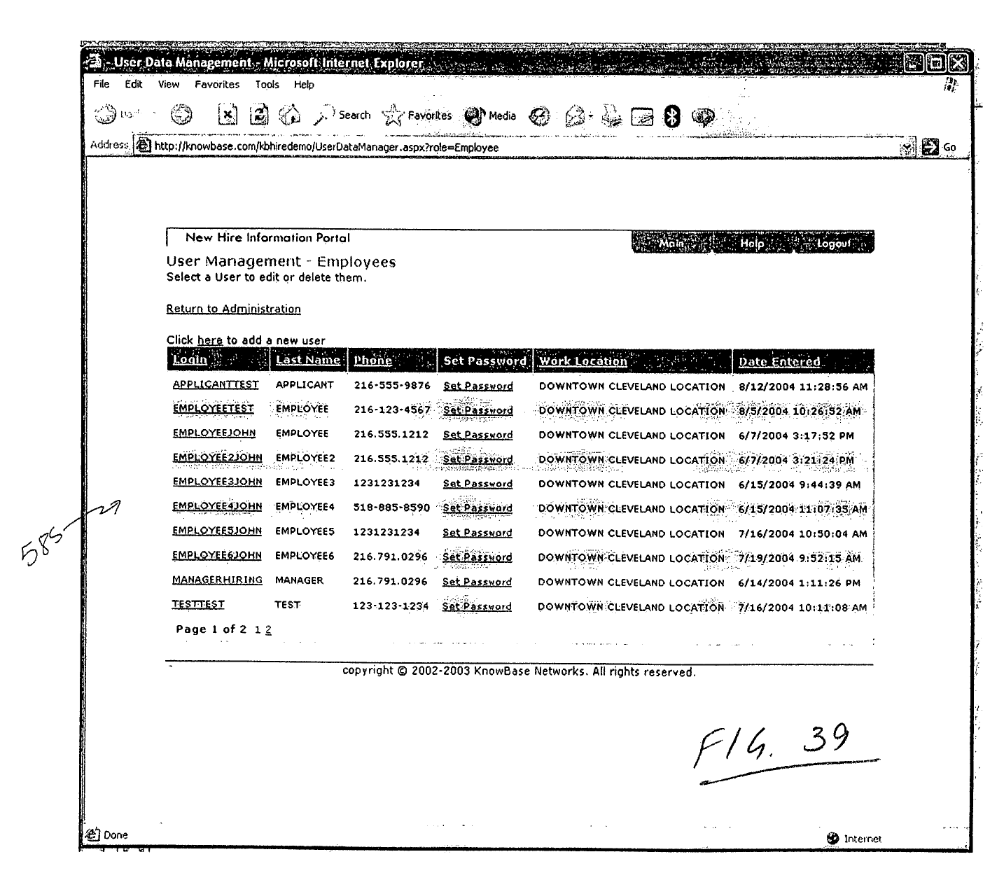

Referring next to FIG. 39, a screen shot of a manage employees screen for the human resource administrator 585 is shown. The screen shot of a manage employees screen for the human resource administrator 585 is produced by the web based employee hiring management and tracking software 10 when the user selects the manage employees button 540 (as shown in FIG. 30). The screen shot of a manage employees screen for the human resource administrator 585 would be used to add, delete or edit the various employees comprising the database of the web based employee hiring management and tracking software 10.

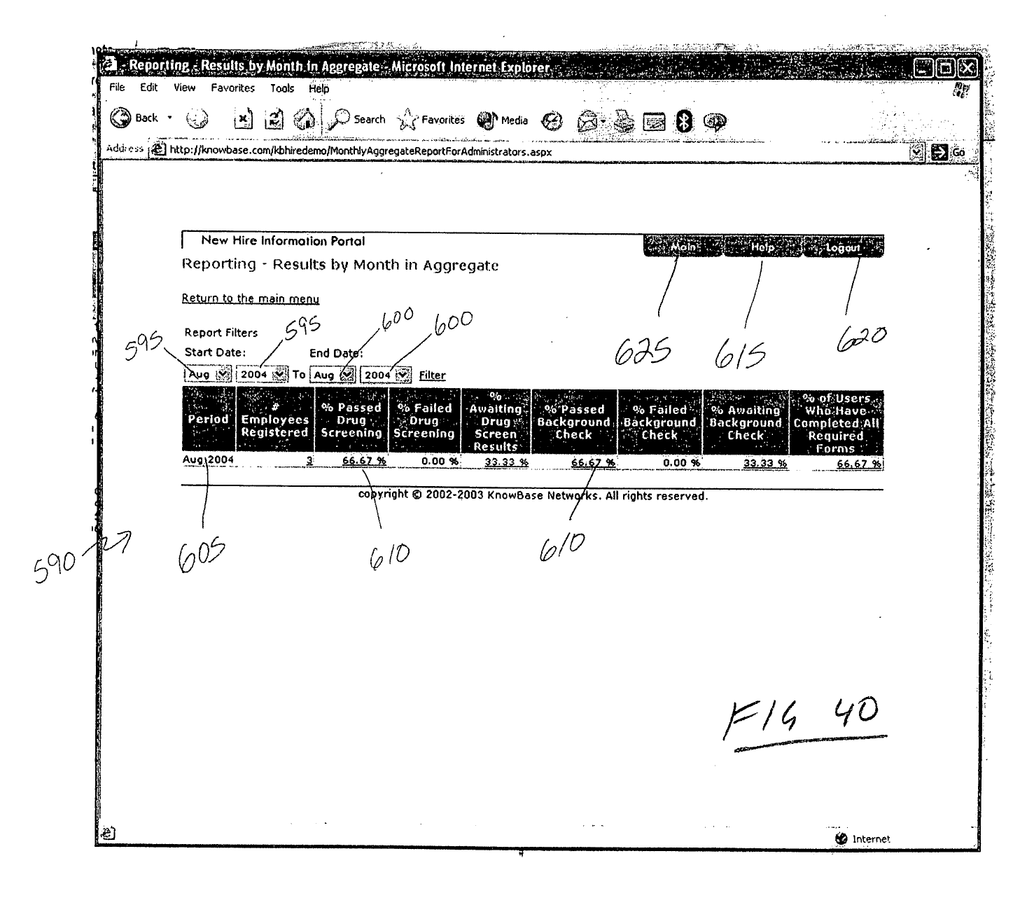

Referring next to FIG. 40, a screen shot of a reporting screen for the human resource administrator 590 is disclosed. A third pull-down start date filter 595 and a third pull-down stop date filter 600 allow the user to customize the supplied report for a specific recording period. Once selected, a third reporting period 605 is provided with corresponding third reporting data fields 610 that provide data to the human resource administrator. The specific third reporting data fields 610 can also be inquired upon directly to provide the specific data that comprises the corresponding third reporting data fields 610. It should be noted that the screen shot of a reporting screen for the human resource administrator 590 as well as most previously described screens feature a third help button 615, a third logout button 620 and a third main menu button 625. Accessing the third main menu button 625 will return the user to the corresponding main menu for the type of user accessing the web based employee hiring management and tracking software 10. In the case of the human resource administrator, he or she would be returned to the screen shot of a main menu selection screen for the human resource administrator 435 (as shown in FIG. 28)

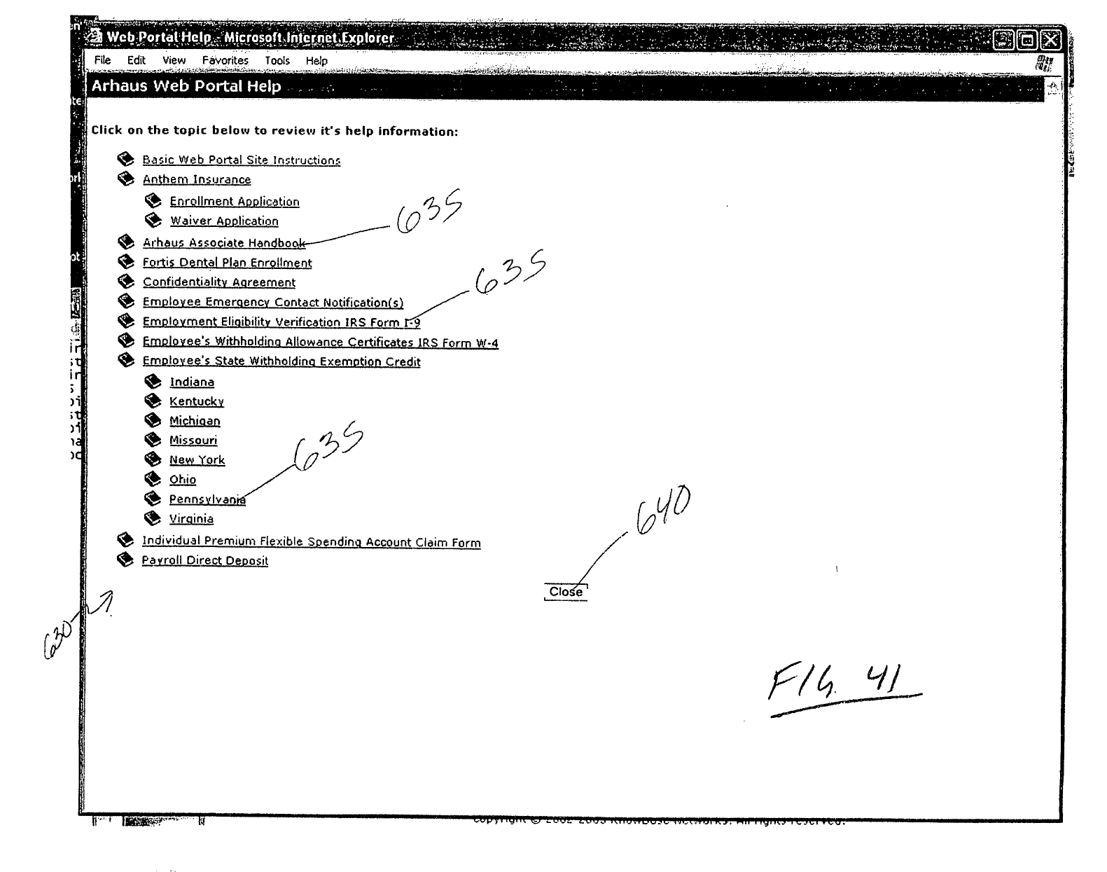

Referring now to FIG. 41, a screen shot of a help screen for the human resource administrator 630 is depicted. The screen shot of a help screen for the human resource administrator 630 is accessed whenever the user clicks upon the third help button 615 (as shown in FIG. 40) The screen shot of a help screen for the human resource administrator 630 is envisioned as a new browser window that allows the user to access the supplied help functions and the main screens as previously described simultaneously. The screen shot of a help screen for the human resource administrator 630 provides a plurality of fourth topics 635 in the customary manner as well as a fourth close button 640 to allow the user to cease operation of the screen shot of a help screen for the human resource administrator 630 as well.

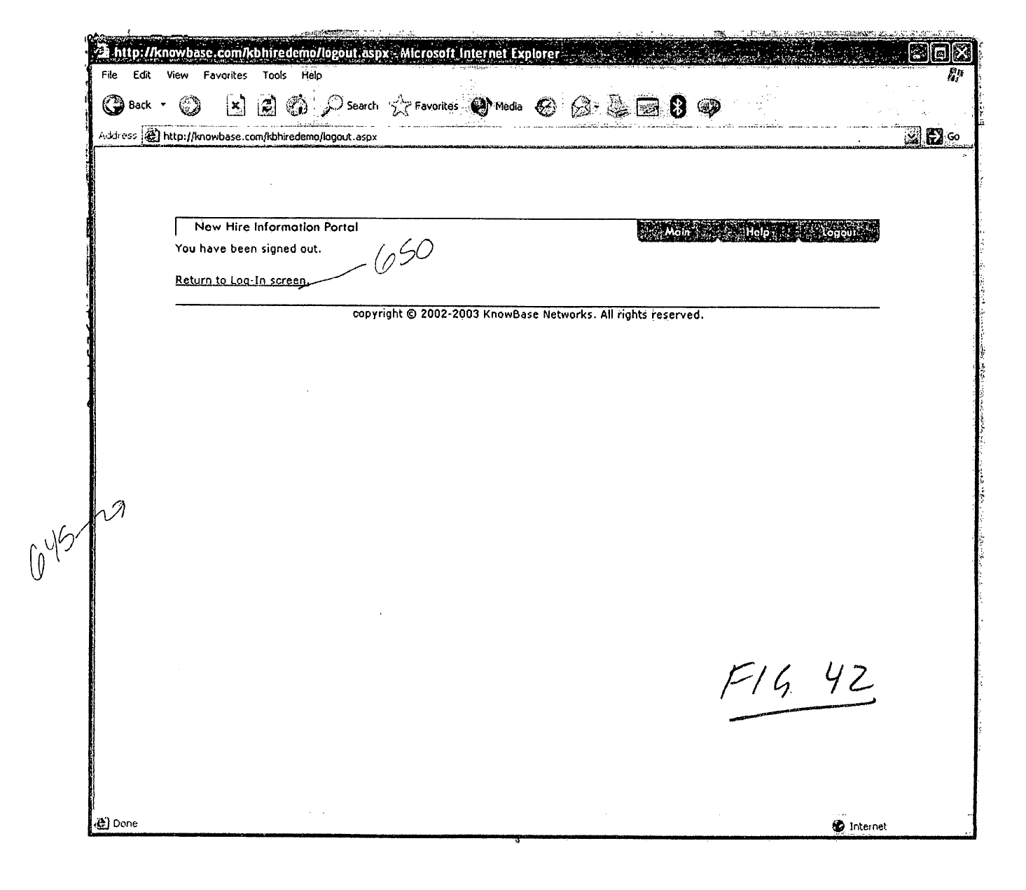

Referring now to FIG. 42, a screen shot of a logout screen for the human resource administrator 645 is shown. The screen shot of a logout screen for the human resource administrator 645 is accessed whenever the user clicks upon the third logout button 620 (as shown in FIG. 40). Such functionality allows the user to end the interactive session with the web based employee hiring management and tracking software 10. Should the user change his or her mind, or reach the screen shot of a logout screen for the human resource administrator 645 by mistake, a fourth re-login button 650 is provided to allow the user to reconnect by redirecting the user to the screen shot of a main login screen 15 (as shown in FIG. 1)

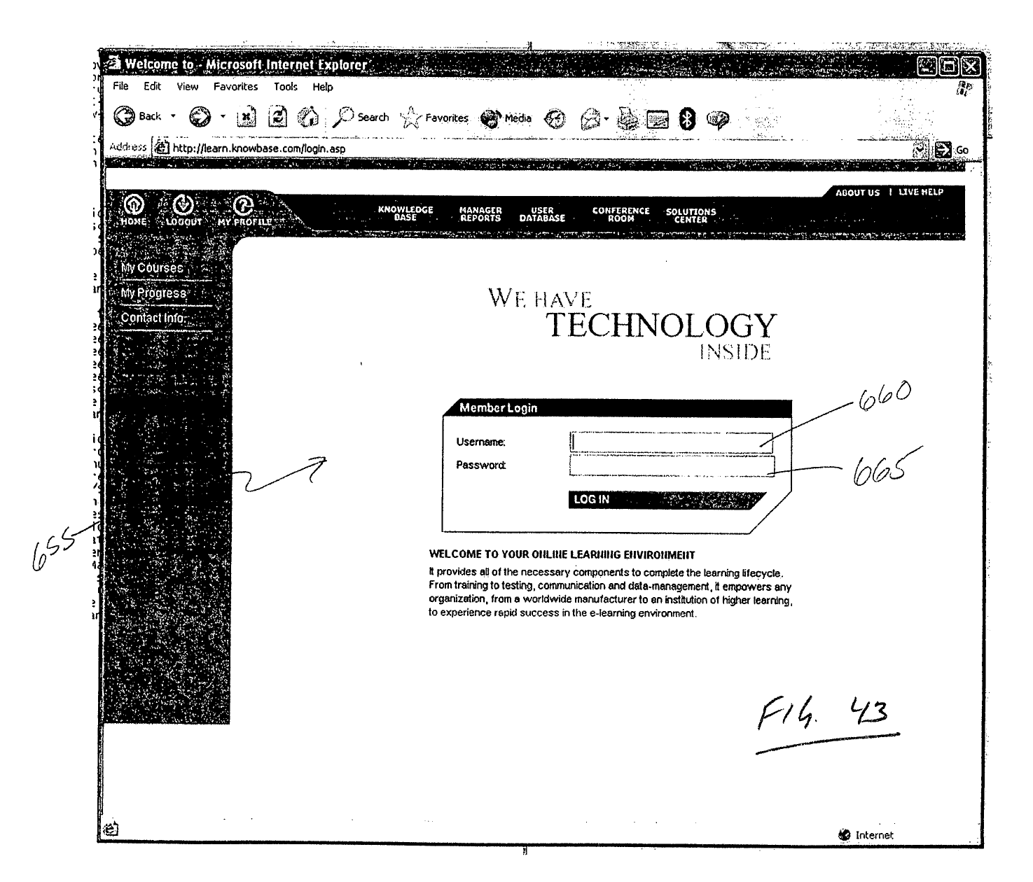

Referring next to FIG. 43, a screen shot of a login screen for the training manager 655 is depicted. The screen shot of a login screen for the training manager 655 can be an integral part of the web based employee hiring management and tracking software 10, or be provided as a separate database solely for the purposes of managing training, not only for new employees before beginning their work, but also for current employees who need training to keep up with new systems, procedures, technology and the like. The screen shot of a login screen for the training manager 655 provides a second user name field 660 and a second password field 665 as would be expected in a typical login screen.

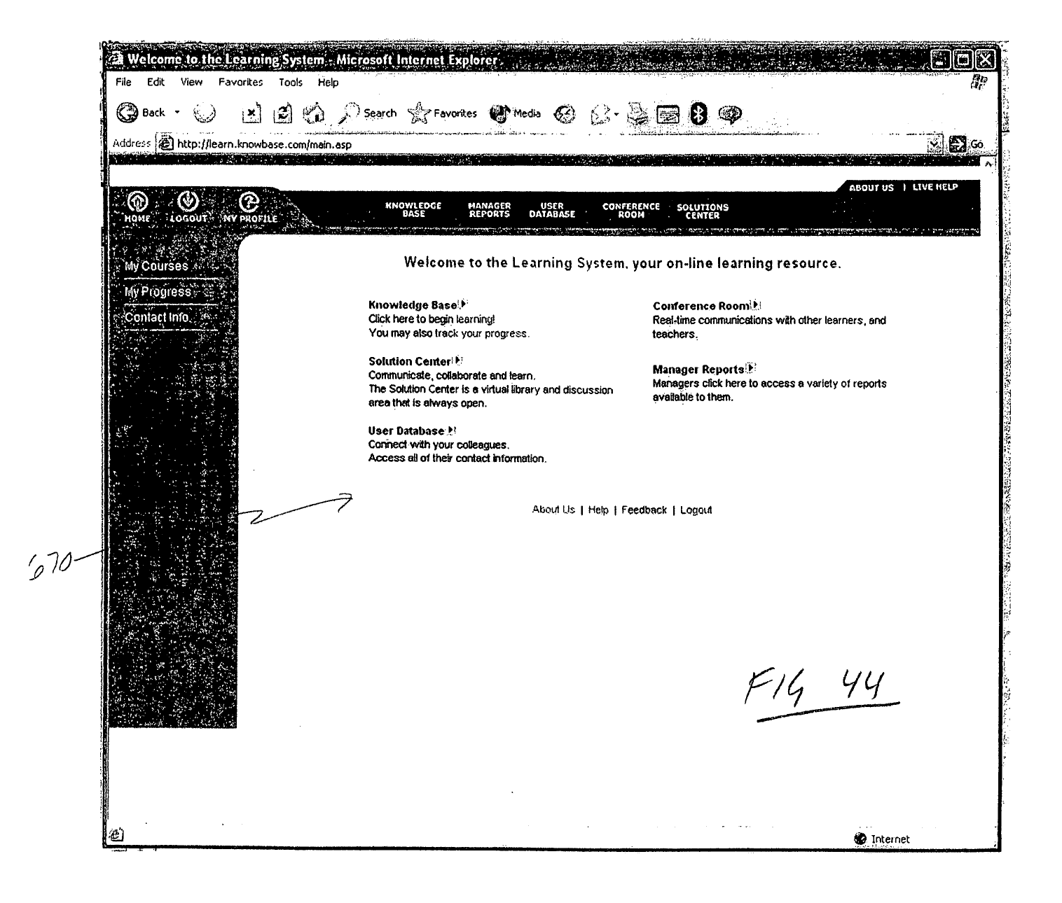

Referring now to FIG. 44, a screen shot of a main menu screen for the training manager 670 is provided. The screen shot of a main menu screen for the training manager 670 provides the training manager access to various training functions such as user databases, solution centers, knowledge bases, reports, real time communications and the like associated with training exercises. It should be noted that the functionality associated with the screen shot of a main menu screen for the training manager 670 is easily customizable by simply programming, and as such allows a wide range of functionality associated with widely varied training programs associated with different industries, companies, and organizations.

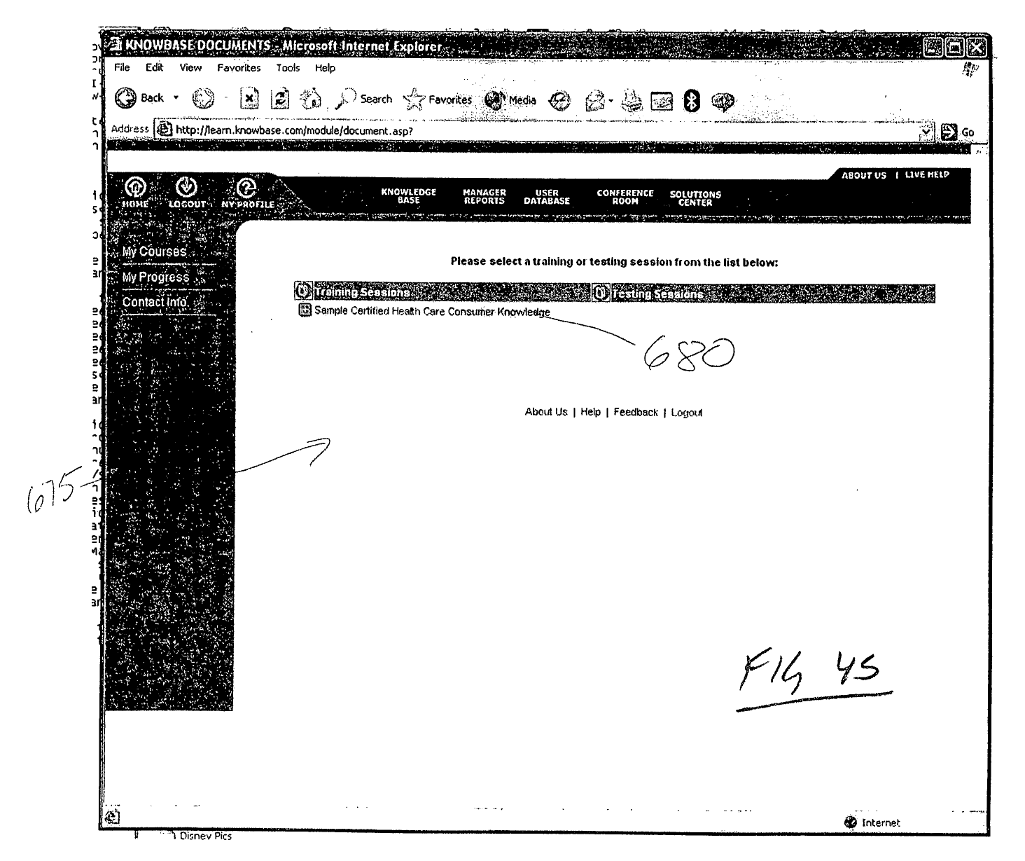

Referring next to FIG. 45, a screen shot of a my courses main menu screen for a training manager 675 is shown. The screen shot of a my courses main menu screen for a training manager 675 provides access to a list of training courses 680. The specific training course as selected from the list of training courses 680 can be assigned to any specific employee or taken by the training manager.

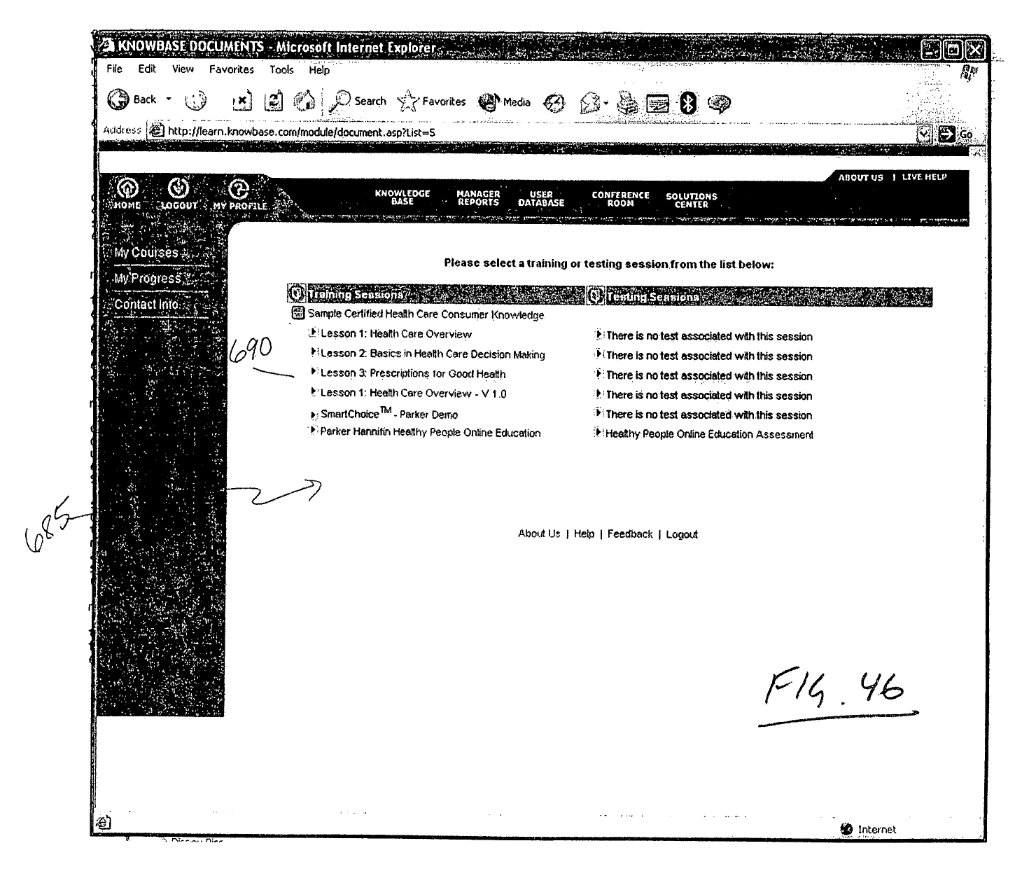

Finally referring to FIG. 46, a screen shot of a detailed course menu screen for the training manager 685 is depicted. The screen shot of a detailed course menu screen for the training manager 685 provides detailed course information on a specific lesson of a training course 690 as selected by the list of training courses 680 (as shown in FIG. 45). It is envisioned that various specific lesson of a training course 690 can be completed by the student as necessary or as time permits. When returning to the web based employee hiring management and tracking software 10, the screen shot of a detailed course menu screen for the training manager 685 would indicate which specific lesson of a training course 690 have been completed, and which still require completion.

It is envisioned that other styles and configurations of the present invention can be easily incorporated into the teachings of the present invention, and only one particular configuration shall be shown and described for purposes of clarity and disclosure and not by way of limitation of scope.

2. Operation of the Preferred Embodiment

The preferred embodiment of the present invention can be utilized by the common user in a simple and effortless manner. The network connected client (including but not limited to any Internet browser, Intranet client, PDA device, etc.)-based employee onboarding and tracking software 10 is best described in conjunction with FIG. 1, through FIG. 46.

The web network connected client (including but not limited to any Internet browser, Intranet client, PDA device, etc.)-based employee onboarding and tracking software 10 is accessed through a standard personal computer with an Internet connection and suitable software for web browsing installed. It is envisioned that this computer could be one at the users office, the client office, a home computer, a notebook computer with a dial-up connection, one at an Internet café, or the like. The invention is accessed by browsing to a specific web site where a screen shot of a main login screen 15 is displayed as shown in FIG. 1. The user would enter his or her first user name field 20 and first password field 25. Provided with such information, the web based employee hiring management and tracking software 10 would determine if the user is a hiring manager, a background screening administrator, an employee, a human resource administrator, a training manager or the like. In the case of a is a hiring manager, the web based employee hiring management and tracking software 10 presents the instruction screen for hiring manager 35. In the case of a background screening administrator, the web based employee hiring management and tracking software 10 presents the screen shot of a main menu selection screen for background screening administrator 225. In the case of an employee, the web based employee hiring management and tracking software 10 presents the screen shot of a main menu screen for the employee 350. In the case of a human resource administrator, the web based employee hiring management and tracking software 10 presents the screen shot of a main menu selection screen for the human resource administrator 435. Finally, in the case of a training manager, the web based employee hiring management and tracking software 10 presents the screen shot of a login screen for the training manager 655.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents. Therefore, the scope of the invention is to be limited only by the following claims.

What is claimed is:

1. A human resources facility for providing integrated processing of new hire employees comprising at least one server locations and a plurality of client locations associated with each of said at least one server, comprising:
at least one processing component for gathering information about said new hire employees;
at least one storage component associated with said at least one processing component for tracking said gathered information;
at least one communication component for effecting communication from said at least one processing component to said at least one storage component.

2. The human resources facility for providing integrated processing of new hire employees of claim 1, wherein said at least one storage component comprises a central computerized database.

3. The human resources facility for providing integrated processing of new hire employees of claim 1, wherein said at least one communication component comprises a network connected client (including but not limited to any Internet browser, Intranet client, PDA device, etc.)

4. The human resources facility for providing integrated processing of new hire employees of claim 1, wherein said at least one processing component further comprises:
at least one selected form link to provide access to multiple governmental forms which must be completed prior to employment; and
at least one selected form link to provide access to multiple non-governmental forms which must be completed prior to employment.

5. The human resources facility for providing integrated processing of new hire employees of claim 4, wherein said government forms include forms selected from the group comprising: form I-9; and form W-4.

6. The human resources facility for providing integrated processing of new hire employees of claim 1, further comprising a reporting component capable of providing a list of potential employees undergoing hiring process.

7. The human resources facility for providing integrated processing of new hire employees of claim 1, further comprising access for a human resource administrator to allow changes to work place descriptions that may be serviced by an organization.

8. The human resources facility for providing integrated processing of new hire employees of claim 1, further comprising an application module operative to provide an application service to at least one user; and wherein the server module is operative to control access to the application module.

9. A method for processing new employee hiring information comprising the steps:
a. accessing a main database through a standard personal computer or other applicable interfacing device with a network connected client (including but not limited to any Internet browser, Intranet client, PDA device, etc.);
b. populating said main database with information necessary for the processing of new employees; and
c. creating governmental forms which must be completed prior to employment utilizing the information populated to said database.

10. The method of claim 9, further comprises the steps:
a. creating non-governmental forms required by a hiring organization or employee optional forms to be completed prior to employment utilizing the information populated to said database;
b. tracking, within said database, training activities performed by a new employee after being hired.
